(19) United States
(12) Patent Application Publication
(10) Pub. No.: US 2004/0041911 A1
(43) Pub. Date: Mar. 4, 2004

(54) Portable information terminal and digital camera for portable information terminal and portable digital camera/information terminal system

(75) Inventors: Kenji Odagiri, Tokyo (JP); Katsuya Kita, Soka-shi (JP); Kenichi Yamashita, Tokyo (JP); Shunji Ishikawa, Kawasaki-shi (JP); Tetsuya Kamijo, Tokyo (JP); Susumu Honda, Kitakatsushika-gun (JP); Tomoya Iwashige, Tokyo (JP); Yasuhiro Sunaga, Yokohama-shi (JP); Hirofumi Oishi, Koshigaya-shi (JP); Shigeyuki Beppu, Yokohama-shi (JP); Yasunobu Somei, Yokohama-shi (JP)

Correspondence Address: Schulte Roth & Zabel, Intellectual Property Docketing, 919 Third Avenue, New York, NY, 10022, US

(73) Assignees: Kyocera Corporation, Kyoto (JP); KDDI Corporation, Tokyo (JP)

(21) Appl. No.: 10/229,713

(22) Filed: Aug. 27, 2002

(51) Int. Cl. H04N 5/225

(52) U.S. Cl. 348/207.1

(57) ABSTRACT

A portable information terminal such as mobile communication terminal having an earphone jack for sound input/output, PHS (personal handy-phone system), PDA (personal digital assistants), and mobile personal computer; a digital camera to connect to the portable information terminal, a digital camera connected portable terminal device comprising the portable information terminal and the digital camera, as well as to a method of controlling such a portable information terminal. The existing earphone jack provided on portable information terminals can be adopted as the plug for the digital camera or insertion plug for the connector of USB cable, so that the cost can be lowered and the system made compact to provide a highly flexible portable information terminal and a digital camera for use with the portable information terminal.

### CROSS REFERENCE TO RELATED APPLICATION

This application claims priority to

PCT Application No. PCT/JP01/01497 filed on Feb. 28, 2001, 2000 which in turn claims priority to

Japanese Patent Application No. 2001-003533 filed on Jan. 11, 2001,

Japanese Patent Application No. 2000-333948 which was filed on Oct. 31, 2000,

Japanese Patent Application No. 2000-333950 which was filed on Oct. 31, 2000,

Japanese Patent Application No. 2000-333951 which was filed on Oct. 31, 2000,

Japanese Patent Application No. 2000-155390 which was filed on May 25, 2000, and

Japanese Patent Application No. 2000-053113 filed on Feb. 29, 2000

### TECHNICAL FIELD

The present invention relates to a portable information terminal such as portable phones having earphone jack for sound input/output, PHS (personal handy-phone system), PDA (personal digital assistants), mobile personal computers, a digital camera for use with the portable information terminal, a portable digital camera/information terminal system comprised by a information terminal and a digital camera; and a method of controlling the portable information terminal.

### BACKGROUND ART

In recent years, in the milieu of increasing speed of data communication using portable information terminals and significant progress that has been achieved in information communication technologies, portable telephones have transformed themselves from a usage as telephone to an integrated information tool that is being accepted rapidly.

With such a trend, customer needs have expanded from basic information such as images, music, mail to higher levels of content such as moving images and programs, and it is anticipated that even more applications will be created in the future.

In response to such needs of consumers, machines that might be termed information vending machines have begun to appear in the marketplace to provide a service of selling not only sound data information but information of various other kinds that can be accessed by connecting a portable information terminal to the information vending machine with a special cable.

When receiving information from an information vending machine using such a special cable, it is necessary to insert a connector of the cable to the portable terminal, but because the connector has a front side and a back side to ensure that the connection is made in a fixed direction, that the user must confirm front and back surfaces of the connector resulting in a problem of inconvenience.

Also, when the connector is inserted into the portable terminal, locking mechanism of the connector operates and the connection becomes locked, but if the user tries to pull the connector out without realizing that it is locked, the connector can be subjected to excessive load and damage may result. Also, when the portable telephone and PHS are used as a communication device for mobile computing, a PC card is normally used as an interface, and therefore, it is necessary to carry the PC card and connection cables when one is travelling, which present another inconvenience. Also, some computers have only one PCMIA (personal computer memory card international association) slot for inserting a PC (personal computer) card so that, when this slot is taken up by the portable telephone, other devices cannot be connected, which has been an annoyance. Further, if it is desired to use some peripheral device, the PC card inserted into the PCMIA slot must be exchanged to another card, resulting in a problem of time-consuming handling.

In the meantime, in response to a need for transmitting images recorded in a digital camera to another terminal by connecting the digital camera to the portable terminal, Japanese Patent Applications, First Publications, Hei 10-341302 and Hei 11-08823 disclose a technique of chord-based connections such as IRDA (infrared data access) or RS-232C (serial connection) to connect the digital camera to the portable terminal for transmitting the data.

However, in transferring image data using chords such as IRDA or RS232C, problems with handling and portability arise.

Also, conventional digital cameras are expected to be connectable to various general portable communication terminals such as portable telephone terminal, PHS, PDA, mobile personal computers, so that, even though a display section such as liquid crystal monitor and an operation section are provided for the portable terminal, they are often provided for the digital camera also, and handling becomes complex and the cost of the combined system increases. Also, because it is not possible to supply power from a device to which the camera is connected, the camera itself must have a power source, and the size of the casing increases, thus making it unsuitable as a portable device. As explained above, it has been difficult, in the past, to avoid the complexity of camera structure and realize a highly convenient digital camera.

Image data is generally transferred serially according to EIA (Electronic Industry Association) standard, but IRDA and RS-232 and others always require special interfaces. Also, in addition to data transfer methods using cables as described above, a Japanese Patent Application, First Publication, Hei 06-268582 discloses a technique of data transfer through a medium such as a memory card, but even when using such a technique, interface circuit and driver circuit are necessary. For this reason, when connecting a digital camera to a portable communication terminal, expensive parts and interfaces were required in the past, presenting a problem that it has been difficult to reduce the size of the digital cameras and portable terminals or to reduce the combined system cost.

Furthermore, when using RS-232C cable such as the one described above, serial communication according to EIA RS-232C standard is used, but in normal serial communication, it is necessary to perform the so-called “handshake operation” by exchanging certain commands between the portable terminal and the digital camera, before commencing communication so that image data are transferred after confirming that both sides are in operational states. Thus, image data transfer operation cannot be started promptly. Also, in serial communication, information to discriminate start and finish of individual data is attached to each byte (=8 bits) of data, so that, when 2-bits of the 8-bits are used for discrimination purpose, the amount of information that can be carried by 1 byte is only 6 bits, causing the data themselves to be processed inefficiently. In addition to this problem, although parallel communication that increases the transfer speed by increasing the number of serial lines is known, the parallel data transfer technique is not preferable because it increases the system cost due to the fact that the number of signal lines must be increased in the connection terminal of the devices such as digital camera and portable communication terminal that demand small size, light weight and low cost.

Also, when recording images with a digital camera, the user must perform several operations, such as: selecting the image recording mode by operating the keys of the operation section provided on the portable terminal while confirming the settings on the display section of the terminal; pressing the define key to define the image recording mode; and then recording an image in the image recording mode. Furthermore, when the portable terminal is a portable telephone, for example, it is necessary to operate at least two keys, one key for switching from the sound mode of the telephone function to the image recording mode of the camera function, and another key to define a task in the selected mode. Further, it is necessary to provide operation keys required for image recording, for example, a key to function as the shutter button, and settings keys to specify recording conditions and others. Therefore, the number of keys to be operated such as switching to the recording mode and operating the camera is increased, resulting in a problem that, when one is ready to record a picture, some time is spent in operating the keys before reaching the stage of defining the recording mode. Additionally, to define the image recording mode, it is necessary to select the image recording mode first and then to operate the definition keys, so that the user is required to view the display section of the portable terminal while operating the keys to define parameters of the image recording mode, so that the problems are not only complex key operations but also a missed opportunity for recording good images.

### SUMMARY OF THE INVENTION

The present invention is provided in view of the background information present above, and a first object of the invention is to provide a portable information terminal that enables to communicate data with an external device in a highly convenient manner because of its simplified cable connection.

A second object of the invention is to provide a user-friendly digital camera that enables to freely change the direction of image recording without making the camera structure complex for use with a portable information terminal having an earphone jack for sound input/output, and a portable information terminal for use with such a digital camera, and a digital camera/information terminal combination system.

By virtue of the fact that a portable information terminal is already provided with an earphone jack for sound input/output purposes so that this jack can be used for transferring data purposes, a third object of the invention is to provide a portable information terminal and a digital camera for the information terminal and a portable digital camera/information terminal system that does not require a special connection device or expensive interfaces.

A fourth object of the invention is to provide a portable information terminal, and a digital camera for the portable information terminal and a portable digital camera/information terminal system that enables the user to transmit image data easily, rapidly and efficiently using serial transmission in particular.

A fifth object of the invention is to provide a portable information terminal and a method for controlling the portable information terminal that can be operated using a lesser number of keys without the need to look at the screen in the display section and without providing a dedicated key for image recording.

According to the first aspect of the present invention, a portable information terminal is provided comprising a jack having a first and a second transfer contacts for transmitting-receiving data, which connects to a contact for transmitting/receiving data 173, 174 of the connector 101 as shown in FIG. 12. According to this structure, because there are two contacts for data communication, it enables the portable information terminal to connect to a connector such as a USB connector having a similar structure.

The second aspect of the portable information terminal relates to the jack, which further comprises a power supply contact, which connects to a contact for the power supply 171 of the connector 101 shown in FIG. 12, and a ground contact, which connects to a contact for the ground 172 of the connector 101 shown in FIG. 12. According to this structure, because the power supply contact and the ground contact are provided, power can be supplied from an external source.

The third aspect of the portable information terminal relates to the jack having contacts arranged in order, from an inner side toward an outer side of the terminal body in the following order: the first data transfer contact, the second data transfer contact, the ground contact, and the power supply contact. According to this structure, because a case section having a large contact area is selected as the contact for the power supply, problem of poor contact can be avoided even when it is rotated in complement. Also, incomplete insertion of the plug does not cause power shorting because nearby contact is transmitted. In particular, the terminal side troubles are prevented because the power supply contact and the ground contact are arranged in the same way as an earphone plug.

The fourth aspect of the portable information terminal relates to the jack usable with an earphone jack. According to this structure, because an earphone jack in any existing portable information terminal can be used as data communication terminal, there is no need for providing a new connector for USB cable connection. Also, the earphone jack can be rotated 360 degrees about the plug axis, and because there is no need to confirm the orientation of the USB connector for insertion into the jack, it is convenient to use. Further, because there is no locking device for the earphone jack, the plug connector may be removed without concern about potential damage. Portable telephones, PHS, PDA are examples of portable information terminals that can use the jack as the earphone jack in accordance with the invention.

The fifth aspect of the portable information terminal relates to the jack having the first data transfer contact, corresponding to the contact for transferring data 11d of the plug 10 of the digital camera 1, usable for data line, and having the second data transfer contact, corresponding to the contact for transferring a clock signal 11c of the plug 10 of the digital camera, is usable for a clock signal line.

According to this structure, contacts for earphone microphone can be used to transfer image data produced by the digital camera, and it contributes to making a multi-purpose portable information terminal.

A further aspect of the portable information terminal is that it further comprises a circuit switching section (switching section 125 or 126 in the embodiment) which connects the jack to a sound circuit (sound interface 19a in the embodiment) or a data processing circuit (USB interface 19c in the embodiment).

According to this structure, a circuit (interface) for processing input data can be switched to suit an external device connected to the jack, data processing appropriate to the external device can be carried out.

Another aspect sixteen of the portable information terminal relates to the circuit switching section connecting the jack to the data processing circuit (USB interface 19c) when information relating to data transfer start is input to the circuit switching section (in the embodiment described later, when the user uses the operation section 23 to switch to the USB mode, and a signal so notifying is input from CPU 26, or a specific signal to indicate that USB cable 100 has been connected is input by an external device).

According to this structure, when it is detected that USB cable has been connected, the circuit switching section automatically switches the target connection of the earphone jack, so that processing suitable for various data output from the earphone jack can be performed.

A further aspect of the invention relates to an information terminal comprising a jack having four contacts for a power supply, a ground, transferring a clock signal and transferring data.

According to this portable information terminal, it enables to directly attach the camera mechanically as well as electrically to the portable information terminal by inserting a plug of the digital camera into the jack.

Another aspect of the portable information terminal relates to the four contacts of the jack being arranged, from an inner side toward an outer side of the terminal body, in the following order the contact for transferring data, the contact for transferring the clock signal, the contact for the ground, and the contact for the power supply.

Accordingly, by selecting the case section that has a large contact area as the contact for the power supply, the problem of improper contact can be avoided even when it is rotated in complement. Also, when the plug is only partially inserted, shorting can be avoided because there are no nearby terminals. In the case of earphone microphone, the contact for the ground is located second from the base section so that problems in the terminal can be prevented.

Another aspect nineteen of the portable information terminal relates to the jack being usable with an earphone jack.

According to this structure, because an earphone jack on an existing portable information terminal can be used to perform image data transfer, there is no need to provide a new jack for connecting the digital camera. Also portable information terminal, which can use the jack as the earphone jack include portable telephone, PHS, and PDA, for example.

A further aspect of the portable information terminal relates to the circuit switching section (switching section 25) which selects either a sound circuit (sound interface 19a) or an imaging circuit (imaging interface 19b) according to a signal input into the jack and then connects the selected circuit to the jack.

According to this structure, image recording can be started simply by connecting the digital camera.

Another aspect of the portable information terminal relates to the circuit switching section identifying a connected external device, when a plug of an external device connected to the jack, by measuring an electrical resistance between predetermined contacts of the plug, so that it enables to identify a device connected thereto using a simple circuitry.

Another aspect of the present invention relates to a digital camera for a portable information terminal to which the portable information terminal, having a jack for input/output of signals including sound signals, can be connected. The digital camera comprises a digital camera body having a plug for detachably connecting to the jack, wherein the plug has a circular transverse cross-sectional shape.

According to this structure of the digital camera for the portable information terminal, a digital camera body having a plug for detachably connecting to the jack, so that, when the plug is inserted into the jack of the portable information terminal, the recording angle can be chosen at any direction within the 360 degrees and can be adjusted to any direction by rotating the plug about the axis.

Furthermore, when the plug of the digital camera is connected by inserting directly into the jack of the portable information terminal, the two devices are made into one terminal by being mechanically and electrically connected to each other. Therefore, a connecting cable that was required in the past is no longer required, and because the digital camera and the portable information terminal are converted into a single terminal, it enables one-hand image recording operation.

A further aspect relates to the digital camera for the portable information terminal, in which the plug is disposed so that a tip end of the plug is substantially perpendicular to an optical axis of a lens of the digital camera.

Accordingly, when the plug is connected to the jack which is normally provided on a lateral surface of the portable information terminal, the digital camera can be operated while observing the display section of the portable information terminal.

Another aspect relates to a switching section provided in either the digital camera body or the information terminal for switching between a sound circuit and an imaging circuit, and when the jack and the plug are connected electrically, image data are transferred from the digital camera side to the information terminal by way of the plug and the jack.

Accordingly, image recording operation can be started by simply connecting the digital camera.

Another aspect relates to a mound section provided around a periphery of the plug of the digital camera body, so that, when the plug is inserted into the jack, the mound section is abutted against a periphery of the jack so that when the digital camera is rotated, a surface of the mound section is made to slide against the periphery of the jack. According to this structure, the digital camera can be readily rotated against the portable information terminal, and in this case, the mound section is preferably formed in a convex-shape.

A further aspect of the invention relates to the plug of the digital camera being provided with four contacts for a power supply, a ground, transferring a clock signal, and transferring data.

Accordingly, the digital camera can be operated using the power supplied from the portable information terminal and transmit the recorded image data to the portable information terminal.

Another aspect relates to the four contacts arranged in order, starting from a base section of the digital camera body side, in the following order: the contact for power supply, the contact for the ground, the contact for transferring the clock signal, and the contact for transferring the data.

Accordingly, by selecting the case section that has a large contact area as the contact for power supply, the problem of improper contact can be avoided even when it is rotated in complement. Also, when the plug is only partially inserted, shorting can be avoided because there are no nearby terminals. In the case of earphone microphone, the ground section is second from the base section so that troubles in the terminal can be prevented.

Another aspect relates to the contact for ground and the contact for transferring the clock signal of the plug being electrically isolated.

According to this structure, by detecting the resistance value between the contacts, the portable information terminal recognizes that a digital camera is connected to the portable information terminal.

Another aspect relates to the digital camera having an insertion section for threading a cable, so that a string shaped object can be used to thread through the insertion section to facilitate carrying the camera.

A further aspect forty relates to the digital camera for the portable information terminal having a movable member which supports the plug so as to be movable with the plug; and a guide section which supports the movable member so as to be freely movable along a longitudinal axis of the plug and to enable the plug to be housed in the digital camera body, so that the plug can be stored in the body itself.

Another aspect of the invention relates to a lens cover of the digital camera for protecting the lens of the digital camera, and the lens cover is detachable from the lens by moving it with the movable member, so that the lens can be protected from dust and impact.

In a digital camera having such a structure, by connecting the plug and the portable information terminal using a cable having a first terminal for connecting to the plug electrically and a second terminal for transmitting information output from the plug, the camera is enabled to be moved laterally as well as vertically. Accordingly, it enables the camera to record images over an even wider range.

According to another aspect of the invention, by detecting the resistance value between the contacts, it is possible to inform a portable information terminal that a digital camera is connected to the portable information terminal.

A further aspect relates to a portable information terminal having a contact for receiving data and a contact for transferring a clock signal.

According to this structure, image data can be input from the digital camera into the portable information terminal in a simple manner. Also, any earphone jack that is provided in a conventional portable telephone can be used for the contact for receiving data and the contact for transferring the clock signal, so that there is no need for providing a new terminal.

Another aspect of the invention relates to the portable information terminal further comprising a contact for transmitting data. By providing the contact for transmitting data and connecting it to the contact for receiving data of the digital camera, the portable information terminal is able to operate the digital camera. By so doing, bi-direction data transfer is made possible. Also, because the earphone jack of a conventional portable information terminal has four channels, such an earphone jack can be adopted for the present use even if the contact for receiving data is further provided to result in three contacts.

Another aspect relates to the portable information terminal having a first digital camera connection recognizing section, which comprises a control section, for recognizing that a digital camera has been connected to the portable information terminal, when a clock signal is input in the contact for transferring the clock signal.

According to this structure, simply by having the clock signal input when an external device is connected, the external device can be determined to be the digital camera.

A further aspect relates to the clock line section provided with a second digital camera connection recognizing section, which comprises a control section, for starting a generation of a clock signal when an external device is connected, and for recognizing that the external device is a digital camera when predetermined data are received by the contact for data receiving.

According to this structure, by supplying clock signals and discriminating the data input from an external device corresponding to the clock signal, an external device can be discriminated.

Another aspect relates to a digital camera for a portable information terminal having two contacts comprising a contact for transmitting data and a contact for transferring a clock signal.

According to this structure, so long as the device connected has a contact with two contacts, image data can be transmitted to the connected device in a simple manner without using a complex interface and the like.

Another aspect one relates to the digital camera for a portable information terminal having a contact for receiving data.

According to this structure, data reception becomes possible, and for example, it enables to operate the digital camera from a device being connected to the digital camera.

Another aspect relates to the digital camera for a portable information terminal further having a control section which outputs through the contact for transferring the clock signal a clock signal to the external device when the external device is connected.

According to this structure, by outputting a clock signal from the contact for transferring the clock signal, it enables the device to which the camera is connected to recognize that the digital camera has been connected.

Another aspect relates to the digital camera for a portable information terminal such that when the control section receives the clock signal by way of the contact for transferring the clock signal, the control section outputs predetermined data through the contact for transmitting data.

According to this structure, by transmitting the predetermined data in response to clock signal output from the connected device, it enables the device to which the camera is connected to readily recognize that the digital camera has been connected.

As described above, the present portable information terminal is provided with a contact for transferring a clock signal and a contact for receiving data. The digital camera is provided with a contact for transferring a clock signal and a contact for transmitting data so that by connecting mutually corresponding contacts, the portable information terminal is able to carry out the task of discriminating the external device, or recognizing that the digital camera is being connected. By transmitting image data to the portable information terminal, any images can be displayed on the display section of the portable information terminal. In a case where there is only one data line each, it is not possible to operate the digital camera from the portable information terminal, so that it is preferable to provide a memory of sufficient capacity to store image data that would be transmitted from the digital camera. By providing a contact for transmitting data for the portable information terminal and a contact for receiving data for the digital camera in addition to the two contacts, it becomes possible to operate the digital camera from the portable information terminal. In this case, when the portable information terminal recognizes that the digital camera has been connected as an external device, internal circuits of the portable information terminal are switched to functions to serve the digital camera so that the digital camera can be operated from the portable information terminal by having the operation section becoming the digital camera operation section, for example. There are at most three contacts in each so that the earphone jack of the existing portable information terminal may be adopted as it is for use, and there is no need for providing a special terminal. For communication between the two devices, regardless of whether it is uni- or bi-directional, the pacing synchronized method represent typically by clock synchronized serial interface and UART (universal asynchronous receiver/transmitter) may be used.

Another aspect relates to a portable information terminal comprising a terminal side detection section which detects a transmit-ready signal to indicate a data transmit-able state transmitted from a digital camera; and a receiving section which receives image data transmitted from the digital camera; wherein the receiving section receives image data after the terminal side detection section has detected a transmit-ready signal.

A further aspect relates to the portable information terminal wherein, when the receiving section receives image data, the receiving section detects an abnormality according to a reception abnormality discrimination signal contained in the received image data.

Another aspect relates to the portable information terminal, further comprising an terminal side outputting section which outputs a transmit-request signal to request image data to be transmitted, wherein, when the terminal side detection section detects the transmit-ready signal, the terminal side outputting section outputs the transmit-request signal to the digital camera, and the receiving section receives image data transmit from the digital camera in response to the transmit-request signal.

Another aspect relates to the portable information terminal, wherein the receiving section receives image data in one block when the transmit-request signal is not interrupted.

Another aspect relates to a digital camera for a portable information terminal for a portable information terminal, comprising a camera side outputting section which outputs a transmit-ready signal to indicate an image data transmit-able state to the portable information terminal; and a transmitting section which transmits image data in one block to the portable information terminal; wherein the transmitting section transmits image data to the portable information terminal after the camera side outputting section outputs a transmit-ready signal.

A further aspect of the invention relates to the digital camera for a portable information terminal having camera side outputting section for detecting a transmit-request notification output from the portable information terminal requesting image data to be transmitted, and when the camera side detection section detect the transmit-request signal after the camera side detection section output a transmit-ready signal, the transmitting section transmit image data to the portable information terminal.

Another aspect relates to a method for controlling a portable information terminal to which a digital camera can be connected, wherein when the digital camera is connected to the portable information terminal body and a predetermined key provided in an operation section of the portable information terminal is pressed for a predetermined period of time, the digital camera is placed in a recording state, and in such a condition, if a key or plurality of keys in the operation section is operated, an operation corresponding to a recording function assigned to the key is executed.

Accordingly, there is no need to provide a dedicated key for image recording purpose, so that the lesser number of keys are needed for operation for image recording, and it eliminates the need to switch to the recording mode and to operate in the recording mode while confirming each item on the display section.

A further aspect relates to the method for controlling a portable information terminal, wherein, the digital camera is placed and maintained in the recording state, and when a key of the plurality of keys in the operation section is pressed for a period of time shorter than the predetermined period of time, an operation assigned to the pressed key corresponding to a recording function of the digital camera under the recording state is executed, and in such a condition, if a key of the keys in the operation section is pressed for the predetermined period time, the portable information terminal is placed in a certain key input enabled state.

Here, a certain state demanded by an input-key relates to a state enabled by an input-key such as a start call operation, parameter settings for telephone function or data communication function, composing mails and telephone number entries. Accordingly, switching between an operational state for communication (com mode) and an operational state for image recording (recording mode) is facilitated so that the user-friendly system is provided.

Another aspect relates to a method for controlling a portable information terminal to which a digital camera can be connected, wherein when the digital camera is connected to the portable information terminal body and a predetermined key provided in an operation section of the portable information terminal is pressed for a predetermined period of time, the digital camera is placed in a recording state, and in such a condition, if a predetermined key in the operation section is operated, an operation corresponding to a recording function assigned to the predetermined key is executed.

According to this method, by operating one key, the operating mode can be switched from the com mode to recording mode, so that key pressing error is eliminated and the process is made effortless.

Another aspect to a portable information terminal to which a digital camera can be connected, comprising: operation section having a plurality of keys; and

control section for controlling the portable information terminal in such a manner that, when the digital camera is connected to the portable information terminal body and a predetermined key provided in an operation section of the portable information terminal is pressed for a predetermined period of time, the digital camera is placed in a recording state, and in such a condition, if a key in the operation section is operated, an operation corresponding to a recording function assigned to the key is executed, and there is no need to provide a dedicated key for image recording purpose, so that the lesser number of keys are needed for operation for image recording, and it eliminates the need to switch to the recording mode and to operate in the recording mode while confirming each item on the display section.

A further aspect relates to the portable information terminal, wherein the control section controls the portable information terminal in such a manner that, the digital camera is placed and maintained in the recording state, and when a key of the plurality of keys in the operation section is pressed for a period of time shorter than the predetermined period of time, an operation assigned to the pressed key corresponding to a recording function of the digital camera under the recording state is executed, and in such a condition, if a key of the keys in the operation section is pressed for the predetermined period time, the portable information terminal is placed in a certain key input enabled state.

Accordingly, switching between an operational state for communication (com mode) and an operational state for image recording (recording mode) is facilitated so that the user-friendly system is provided.

A further aspect relates to a portable information terminal to which a digital camera can be connected, comprising: operation section having a plurality of keys; and control section for controlling the portable information terminal in such a manner that, when the camera is connected to a portable information terminal body and a predetermined key provided in an operation section of the portable information terminal is pressed for a predetermined period of time, the digital camera is placed in a recording state, and in such a condition, if a predetermined key in the operation section is operated, an operation corresponding to a recording function assigned to the predetermined key is executed.

Accordingly, by operating one key, the operating mode can be switched from the com mode to recording mode, so that key pressing error is eliminated and the process is made effortless.

The above and other objects, aspects, features and advantages of the invention will be more readily apparent from the description of the preferred embodiments thereof taken in conjunction with the accompanying drawings and appended claims.

### BRIEF DESCRIPTION OF DRAWINGS

The invention is illustrated by way of example and not limitation and the figures of the accompanying drawings in which like references denote like or corresponding parts, and in which:

FIG. 1A is a front view of a digital camera for a portable information terminal in Embodiment 1-1.

FIG. 1B is a side view of a digital camera for a portable information terminal in Embodiment 1-1.

FIG. 1C is a bottom view of a digital camera for a portable information terminal in Embodiment 1-1.

FIG. 1D is a perspective view of a digital camera for a portable information terminal in Embodiment 1-1.

FIG. 2 is an exploded perspective view of the digital camera for the portable information terminal in Embodiment 1-1.

FIG. 3 is a diagram to explain the connecting state of the digital camera for the portable information terminal.

FIG. 4 is a block diagram of a circuit in the connection state of the digital camera for the portable information terminal.

FIG. 5A is a flowchart for the process of image recording and transmitting the recorded image information.

FIG. 5B is a flowchart for the process of image recording and transmitting the recorded image information.

FIG. 6A is a diagram to explain a method of using the digital camera.

FIG. 6B is a diagram to explain a method of using the digital camera.

FIG. 7 is an example of plugging an earphone microphone.

FIG. 8 is an example of plugging a stereo headphone.

FIG. 9 is a schematic diagram of connecting an information terminal and a digital camera using a dedicated extension cable.

FIG. 10 is an example of using the dedicated extension cable as a strap for connecting the digital camera and the portable information terminal.

FIG. 11 shows an external appearance of the digital camera having a housing for storing the plug and a guide.

FIG. 12 is an illustration of a USB cable 100 used in Embodiment 1-2.

FIG. 13 is a block diagram of a circuit configuration of a portable information terminal in Embodiment 1-2.

FIG. 14 is a block diagram of a circuit configuration of a portable information terminal in Embodiment 1-3.

FIG. 15 is an illustration of a portable digital camera connection apparatus comprised by a portable information terminal and a digital camera.

FIG. 16 is a block diagram of the circuit configuration of the portable digital camera connection apparatus.

FIG. 17 shows examples of timing charts of, respectively, output waveforms of (a) the clock line and (b) the data line of the of the digital camera, from each output terminal of the portable information terminal and the digital camera at two contacts.

FIG. 18 shows examples of timing charts of, respectively, output waveforms of (a) the clock line and (b) the data line of the of the digital camera, from each output terminal of the portable information terminal and the digital camera at two contacts.

FIG. 19 shows examples of timing charts of, respectively, output waveforms of (a) clock line and (b) data line of the of the digital camera, and of (c) data line of the portable information terminal from each output terminal of the portable information terminal and the digital camera at three contacts.

FIG. 20 shows examples of timing charts of, respectively, output waveforms of (a) clock line and (b) data line of the of the digital camera, and of (c) data line of the portable information terminal from each output terminal of the portable information terminal and the digital camera at three contacts.

FIG. 21 shows a timing chart of the output waveform from the data line of the digital camera in FIGS. 18, 20.

FIG. 22 is a block diagram of the configuration a portable telephone terminal and a digital camera in Embodiment 3.

FIG. 23 shows timing charts timing chart for transmitting image data from the digital camera 650 to the portable telephone terminal 630.

FIG. 24 is a diagram of the structure of image data S1.

FIG. 25 shows timing charts for clock signal output to data request signal line L1b and image data output to data output signal line L1c.

FIG. 26 is a diagram of an example of a table showing items contained in a header 400a.

FIG. 27 is a diagram of an example of the values of an end marker 400c comprised by data of 2 bytes.

FIG. 28 is a diagram of an example of the output sequence of image data body 400b in image data S1.

FIG. 29 is a block diagram of the configuration of a portable information terminal in Embodiment 4.

FIG. 30 is a diagram of the keyboard in the operation section of the portable information terminal in Embodiment 4 shown in FIG. 29.

FIG. 31 is a flowchart of the control process of the portable information terminal in Embodiment 4 shown in FIG. 29.

FIG. 32 is a flowchart of the control process of the portable information terminal in Embodiment 4 shown in FIG. 29.

### DESCRIPTION OF THE PREFERRED EMBODIMENTS AND THE DRAWINGS

Preferred embodiments of the present invention will be explained in detail in the following.

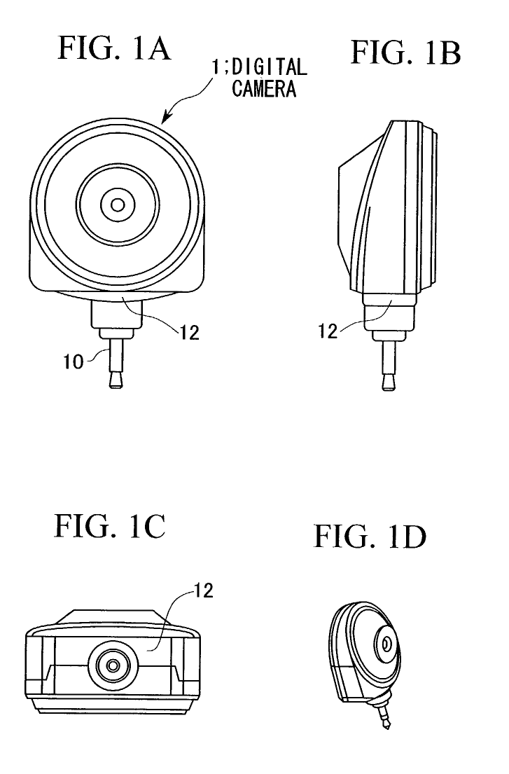

FIG. 1 shows a digital camera for use with a portable information terminal (referred simply as the digital camera in the following), FIGS. 1A-1D are, respectively, a front view, a side view, a bottom view and a perspective view of the digital camera for the portable information terminal in Embodiment 1-1

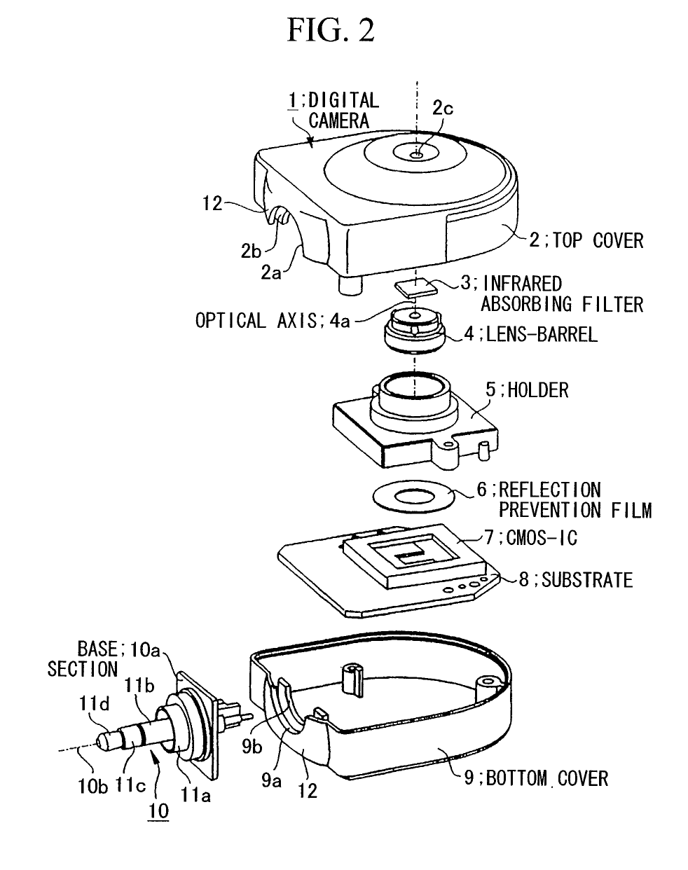

FIG. 2 shows an exploded perspective view of the digital camera in this embodiment. The digital camera comprises by: a top cover 2; an infra-red absorbing filter 3; a lens-barrel 4 constructing the lens system of the camera; a holder 5 for positioning the lens-barrel 4 and blocking light from outside of the optical axis to the imaging element; a reflection prevention film 6 for eliminating harmful reflection light; a CMOS-IC7 for processing imaging element and image data; a base plate 8 for mounting IC7 and other electronic parts; and a bottom cover 9.

On the lower surface of the top cover 2 and the bottom cover 9, semi-circular cutout sections 2a, 9a are provided. Behind each of the cutout sections 2a and 9a, support plates 2b, 9b are provided, and each cutout further has respective support plates 2b, 9b having a cutout each. Here, CMOS-IC7 may be replaced with a CCD-IC.

The plug 10 is attached to the camera body by inserting the bottom section of the base section 10a of the plug 10 between the cutouts 9a 9b of the lower cover 9 and assembling the parts 2-8, placing the top cover 2 and inserting the top section of the base section 10a between the cutout 2a and the support plate 2b. Arranged in sequence from the base section 10a side, in the plug 10 are a contact for power supply 11a, a contact for a ground 11b, a contact for transferring a clock signal 11c, a contact for transferring data 11d. The top cover 2 and the lower cover 9 are fixed by screws (not shown). The structure may be fixed without using screws.

The center axis 10b of the plug 10 is oriented so that it is perpendicular to the optical axis (optical axis of the lens-barrel) 4a of the lens. A mound section 12 is formed as a part of the upper and lower covers surrounding the plug 10. The mound section 12 is a portion that protrudes from the bottom surface of the base section periphery, and it is preferable that it has a convex-shape so that the amount of protrusion decreases gradually as the tip extends from the base section periphery of the plug 10.

Light from the image object propagating through the lens window 2c of the top cover 2 is injected into the lens-barrel 4 by way of the infrared absorbing filter 3, and is focused onto the imaging element CMOS-IC7. Imaging signals accumulated in the imaging elements are converted to electrical signals, processed in the CMOS-IC7, and transmitted to plug 10. Here, it is assumed that the imaging signals are output after being corrected for white balance.

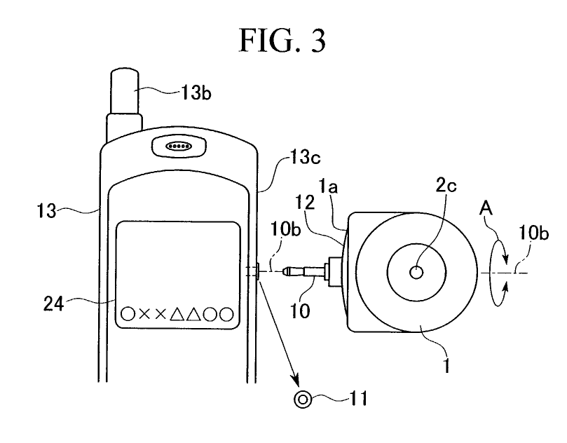

FIG. 3 is a diagram to explain the connection state of the digital camera.

An earphone jack 11 is provided on the right side surface 13c of the portable telephone 13.

A liquid crystal display section 24 is disposed on the front, and an antennae 13b is provided on the top surface.

By inserting the plug 10 of the digital camera 1 into the earphone jack 11 in the direction shown in FIG. 3, digital camera 1 is connected electrically to the portable phone 13 and is mechanically fixed in place.

The earphone jack 11 for connecting the plug 10 can be rotated 360 degrees about the terminal axis 10b, as indicated by a bi-directional arrow “A”, because both terminals are circular shaped. For this reason, with reference to the front surface of the portable telephone 13 having the display section 13c, the lens window 2c of the digital camera 1 can be rotated to any direction in the direction “A” shown in FIG. 3. That is, the lens optical axis (image recording direction) of the digital camera 1 that is perpendicular to the plug 10, can be pointed to any direction within a range of rotation of 360 degrees with respect to the liquid crystal display section 24.

The mound section 12 provided on the bottom surface of the digital camera touches the peripheral side surface of the earphone jack 11 to slide along this section. Accordingly, the distance of protrusion of the digital camera 1 from the portable phone 13 can be minimized, and, the contact area to the portable phone 13 can also be minimized. As a result, the size of the overall apparatus can be made compact, and sliding action to change the recording direction of the digital camera 1 in the connected condition about the terminal axis 10b is facilitated.

Further, because the periphery section 1a of the mound section 12 of the digital camera is distanced away from the side surface 13c of the portable telephone 13, if a digital camera has a lid for the earphone jack 11, the digital camera can be rotated without interfering with the lid of the earphone jack 11 so that the lid does not prevent the digital camera from being seated properly.

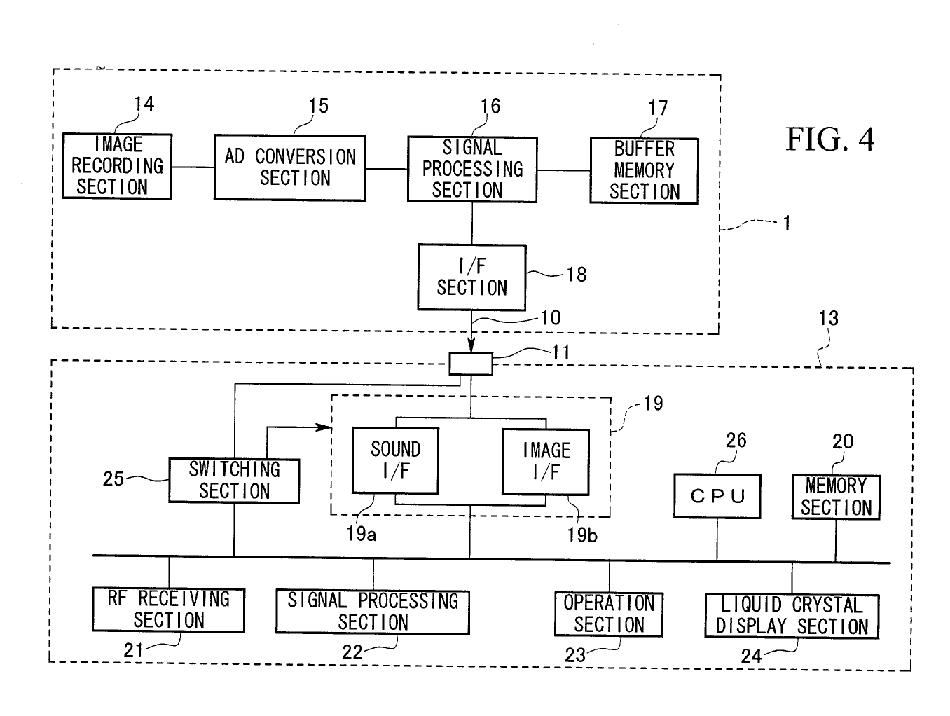

Next, the internal circuit configuration of the digital camera 1 when it is connected to the portable information terminal in Embodiment 1-1 will be shown in FIG. 4. Here, the portable information terminal is represented by a portable telephone (including PHS) in this embodiment.

In the drawing, the digital camera 1 comprises an imaging section 14; an AD conversion section 15; a signal processing section 16; a buffer memory section 17 and an I/F (interface) section 18. In this case, the buffer memory section 17 has a capacity to store one sheet of image, and the memory section 20 comprises a semiconductor memory cards and the like. It should be noted that the image data can be output directly to the portable telephone 13 without storing it in the buffer memory 17.

On the other hand, the portable telephone 13 comprises an I/F section 19 for transferring data between an external device connected through the earphone jack 11; a memory section 20 including ROM, RAM containing various programs and fixed data, an antennae (not shown); an RF transceiver section 21 for transferring sound signals and other data between a destination terminal through a base station; a signal processing section 22 primarily for processing data; an operation section having various keys such as those in a ten-key panel; a liquid crystal display section 24 for displaying various data; a switching section 25 for switching the interface section 19 according to the type of external device; and a CPU 26 for controlling each section by executing the programs stored in the memory section 20.

The interface section 19 is preferably provided with a sound interface (I/F) 19a and an imaging interface (I/F) 19b. The sound I/F 19a responds to analogue sound signals input from an externally connected device such as earphone microphone or stereo headphone, and converts such analog signals to digital signals that can be processed inside the portable telephone and outputs the converted data to signal processing section 22, or converts digital sound data output from the memory section 20 or signal processing section 22 to analog data and outputs such data to the external device through the earphone jack 11.

On the other hand, when the digital camera 1 as the external device is connected to the earphone jack 11, the imaging interface 19b ensures that the data handled by the digital camera 1 and the portable telephone 13 are compatible. That is, image data input from the earphone jack 11 is converted to data that can be processed by the portable telephone and the processed data is output to the signal processing section 22. Alternatively, digital data output from the signal processing section 22 is converted to data that can be processed by the digital camera 1 and the processed data is output to the digital camera 1 through the earphone jack 11.

The signal processing section 22 is a circuit specializing in processing digitized data such as sound data and image data at high speeds, and may comprise a DSP (digital signal processor), for example.

The liquid crystal display section 24 displays various settings of the telephone functions of the portable telephone and various menus as well as various information related to various external devices (earphone and stereo headphone and the like), when an external device is connected through the earphone jack.

ROM is a part of the memory and stores various programs for executing telephone functions, control programs and various fixed data. CPU 26 controls various sections of the portable telephone 13 by executing such control programs. RAM (not shown) temporarily stores data processed by the signal processing section 22, data processed by CPU 26 and various externally input data.

The switching section 25 identifies a device when it is connected to the earphone jack 11, and switches to an interface appropriate to the device being connected.

More specifically, when the switching section 25 detects that a plug is connected to the earphone jack 11, it determines a device type by detecting a value of the resistance between the second and third contacts at the tip of the connected plug, and determines the device type based on this value.

In the following, the process of identifying an externally connected device by the switching section 22 will be explained using specific examples of connecting the digital camera 1, an earphone microphone, and a stereo headphone to the earphone jack 11.

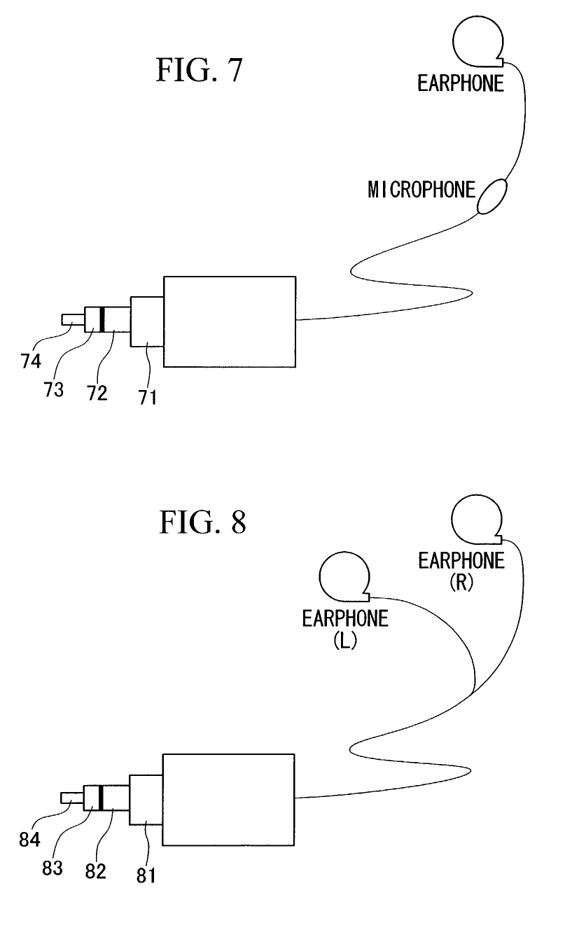

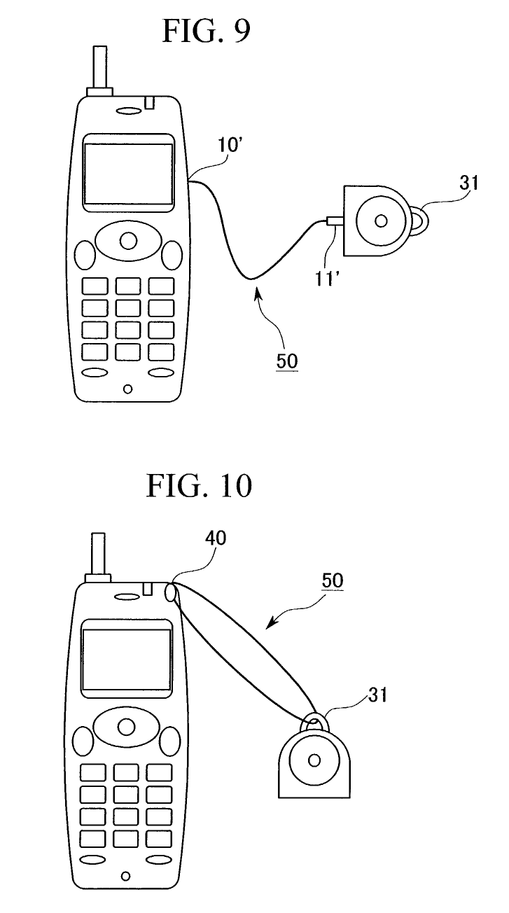

FIG. 7 shows an example of connecting an earphone microphone plug, and FIG. 8 shows an example of connecting a stereo headphone. The earphone plug shown in FIG. 7 has four contacts consisting of a contact for a power supply 71, a contact for a ground 72, a contact for receiving sound data (a contact for an earphone) 73, a contact for transmitting sound data (a contact for a microphone) 74, and of these four contacts, the resistance value between the contact for the ground 72 and the contact for receiving sound data 73 is different than the resistance value between the contact for the ground 72 and the contact for transmitting sound data 74. In contrast, the stereo headphone shown in FIG. 8 has four contacts consisting of a vacant contact 81, a contact for a ground 82, a contact for receiving stereo (L) sound data 83, and a contact for receiving stereo (R) sound data 84, and of the four contacts, the resistance value between the contact for the ground 82 and the contact for the receiving stereo (L) sound data 83 and the resistance value between the contact for the ground 82 and the contact for receiving the stereo (R) sound data 84 are about equal. It should be noted that in the plugs of the earphone microphone and stereo headphone, the terminals are not insulated from each other.

In the plug 10 of the digital camera 1 shown in FIG. 2, the ground section 11b is insulated from the contact for transferring the clock signal 11c so that the resistance value between these terminal is infinite.

Accordingly, the switching section 25 detects a resistance value between contact-2 and contact-3, and if this value is infinite, it is determined that the digital camera 1 is connected, and if it is not infinite, either the earphone microphone or the stereo headphone is connected, so that it further detects a resistance value between the two terminals described above for comparison. If the result of detection shows that the resistance values are identical, it is determined that the connected device is the stereo headphone and if the detected resistance values are different, it is determined that the connected device is the earphone microphone.

As described above, when the switching section 25 determines that the connected device is the digital camera 1, the I/F section 19 selects the imaging interface to correspond to image data so as to enable data communication between the digital camera 1 and the portable telephone 13 through the imaging interface 19b. Also, when the imaging interface 19b is selected, operation keys (not shown) provided on the operation section 23 of the portable telephone 13 function as function keys predetermined for the digital camera 1. Here, image data is processed serially.

Further, in addition to its automatic ability to detect the connection by the digital camera 1 and selecting the imaging interface, the switching section 25 described above may be made to identify that an external device is the digital camera 1 when the user performs a certain operation (mode switching, for example). Also, in this embodiment, the switching section 25 may be provided on the digital camera 1 side.

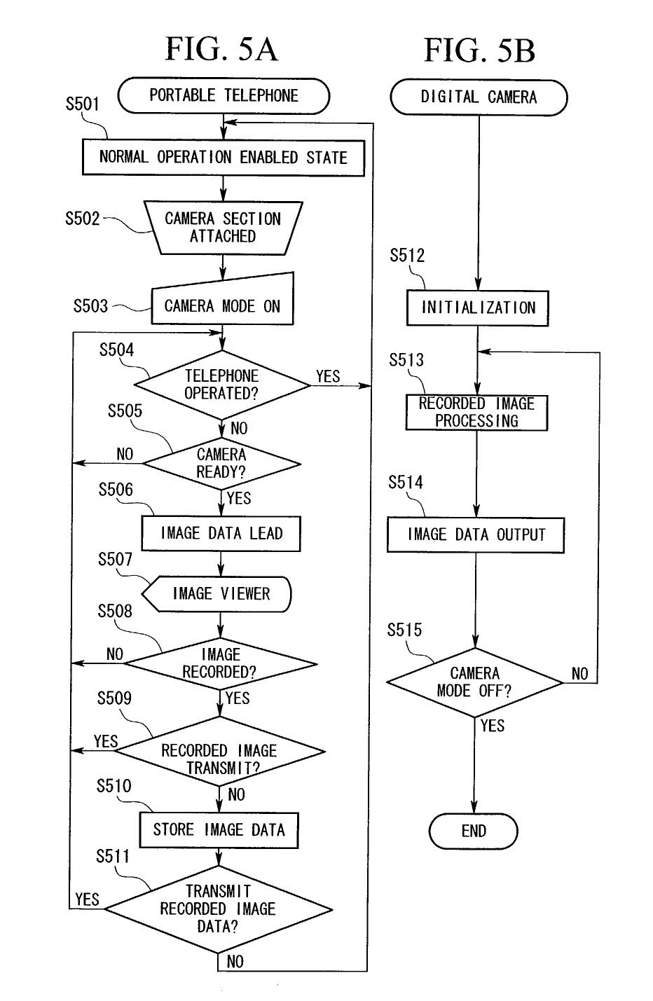

FIG. 5 shows a flowchart for the process from the stage of preparing for image recording to the stage of transmitting image information.

In FIG. 5A, the portable telephone 13 is in the normal operational state (S501). In this state, the plug 10 of the digital camera 1 is inserted and coupled to the earphone jack 11 (S502). The current state is set to the camera mode (S503). The CPU 26 of the portable telephone determines whether telephone operation is enabled, and if the telephone operation is enabled, the flow returns to S501 (S504). If the telephone operation is not enabled, it determines whether the digital camera 1 is enabled (S505). If it is not enabled, the flow returns to S504. If the digital camera 1 is ready to receive image data, image data are read-in (S506).

On the other hand, if in FIG. 5B, the digital camera 1 connected to the portable telephone performs initialization (S512), and the recorded images are processed to output the image data to the portable telephone 13 side through the plug 10 (S513, S514). Then, the flow determines whether the camera mode is in the off-state (S515), and if it is off, the process is finished. In S507 in FIG. 5A, the image output from the digital camera 1 is displayed on the liquid crystal screen of the liquid crystal display section 24. Next, flow determines whether the user has performed the operation to store the image (S508), and if the store operation has been indicated, the image data is transmitted from the digital camera 1 through the plug 10, the earphone jack 11, and the I/F section 19 to the portable telephone 13 (S509), and the image data is stored in RAM of memory section 20 (S510). Next, the flow determines whether the operation is to transmit the recorded image data (S511), and if the transmitting operation has been indicated, the process enters telephone operation in S504, and transmits the image data. If the transmitting operation has not been indicated, the flow returns to the normal terminal operation in S501.

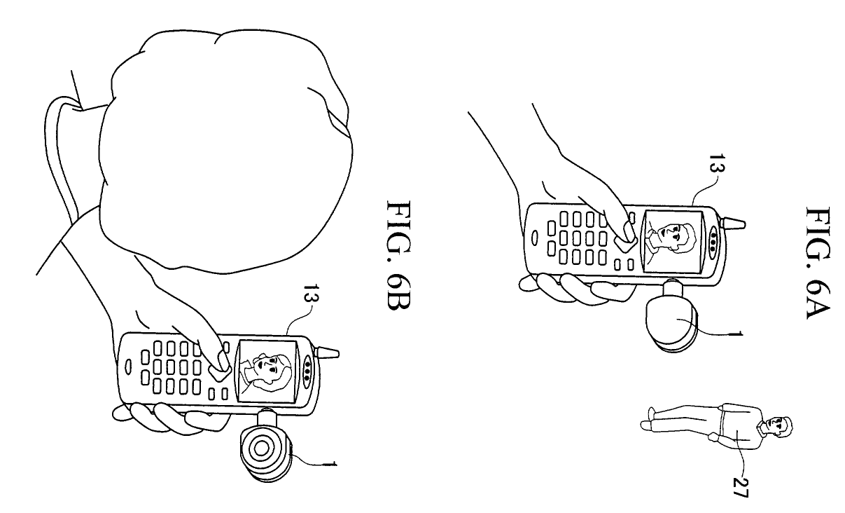

Next, an example of using the digital camera 1 by attaching it to the portable telephone 13 will be explained. FIG. 6A illustrates a case of directing the lens window 2c of the digital camera 1 towards the recording object 27 opposing the user, and recording the image while the user views the image displayed on the liquid crystal display section 24 of the portable telephone 13. In this case, the digital camera 520 is mechanically supported as a terminal by the portable telephone 13, so that one-hand operation is possible.

FIG. 6B illustrates a case of directing the lens window 2c of the digital camera 1 to the user himself holding the portable terminal apparatus attached to the digital camera, and recording an image of self as the recording object while the user views the self image displayed on the liquid crystal display section 24.

As described above, according to the present portable terminal device for connecting the digital camera, the direction for image recording can be changed readily by rotating the digital camera about the plug axis.

By using a dedicated extension cable 50 having an earphone jack 11′ on one end and a plug 10′ on the other end, and connecting the plug 10 of the digital camera 1 to the earphone jack 11′ of the dedicated extension cable 50, and inserting the plug 10′ of the dedicated extension cable 50 in the earphone jack 11 of the portable information terminal, the digital camera 1 can be manipulated in complete freedom. Also, by providing a holder 31 on the digital camera 1, inserting the dedicated extension cable 50 through a strap hole 40 provided originally on the portable information terminal and through the holder 31 of the digital camera 1, and inserting the plug 10′ of the dedicated extension cable 50 into the earphone jack 11′, the digital camera 1 can be attached to the portable information terminal to facilitate its carrying. The shape of the holder 31 is not particularly restricted so long as the opening is sufficiently large to permit the strap to pass through, and such a holder may be placed in any suitable location.

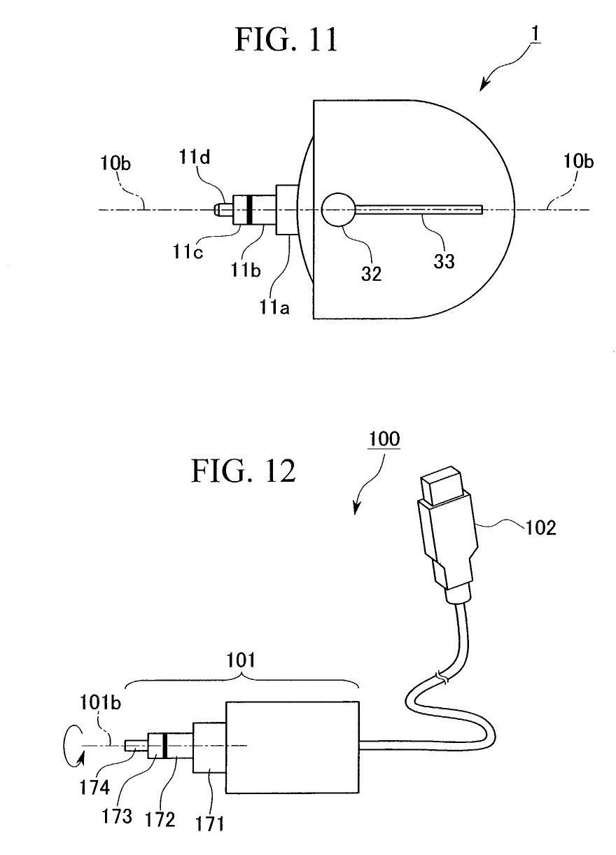

In the above embodiments, by providing a knob 32 linked to the plug 10 and a guide 33 for freely movably supporting the knob 32 along the center axis 10b of the plug 10, as shown in FIG. 11, the plug 10 can be kept with the camera body. Further, by providing a cover for protecting the lens window 2c and linking the lens cover to the knob 32, leans cover may be made detachable by moving the knob 32. Such an arrangement permits to keep the plug 10 with the camera body as well as to place the cover over the lens window 2c.

It is also possible to provide a sensor to detect that the digital camera 1 has been inverted so as to invert the recorded image on the digital camera or on the portable information terminal.

The portable information terminal may be constructed so that location information may be attached to recorded image data by receiving such information from a base station to enable later to identify the location of the recorded image.

Next, the portable information terminal in Embodiment 1-2 will be explained.

In the example shown in Embodiment 1-1, the plug 10 of the digital camera 1 is connected to the earphone jack 11, but in this embodiment, the earphone jack 11 is preferably connected to a connector of the USB (universal serial bus) cable to enable highspeed data transmission with personal computer and the like.

FIG. 12 shows the USB cable 100 which can be used in this embodiment. As shown in this diagram, a connector 101 of the USB cable 100 has a shape to enable to connect to the earphone jack 11. The connector 101 has four contacts, which are arranged from the tip end, in the following order: a first data transmit/receive contact 174, a second data transmit/receive contact 173, a ground contact 172, a power supply contact 171. The USB cable is electrically connected and mechanically fixed to the portable telephone 13 by inserting the connector into the earphone jack 11 provided on the right side surface 13c (refer to FIG. 3) of the portable telephone 13 from the direction shown in FIG. 3. Also, by making a circular cross sectional shape for the connector 101, the connector 101 can be rotated 360 degrees about the center line 101b of the connector 100 as its axis of rotation.

Here, the other connector 102 at the opposite end of the USB cable 100 is connected to an upstream device such as a personal computer, and various data exchanged between the external device. The portable information terminal may include sound data, image data, text data and the like.

Also, of the contact provided on the connector 101, the ground contact 172 and the power supply contact 173 may be left vacant if the power is not to be supplied from an external device.

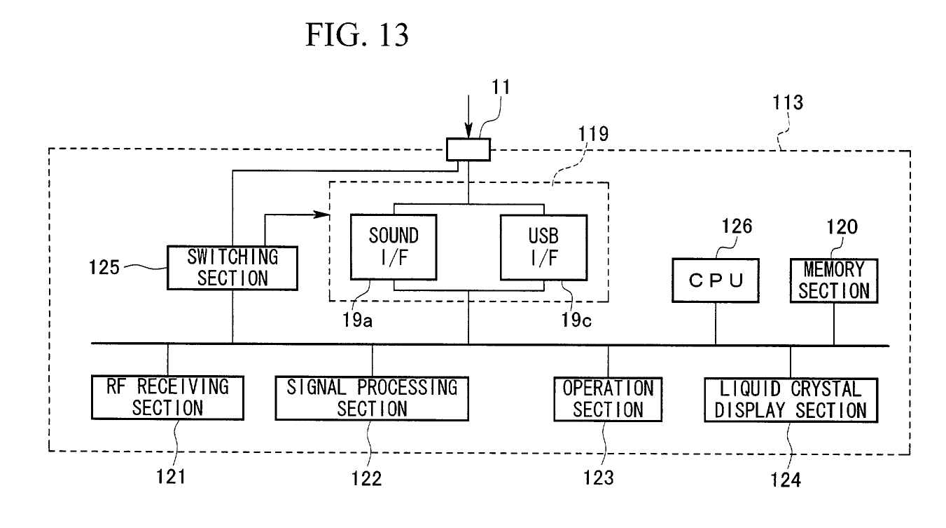

Next, the internal circuit of portable information terminal in this embodiment is shown in FIG. 13. Similar to Embodiment 1-1, the portable phone (includes PHS) is used as the portable information terminal.

As shown in the diagram, the portable telephone 13 has a similar structure as the portable telephone 13 shown in FIG. 4 but the internal construction of the interface section 119 is different.

In this embodiment, the connector 101 of the USB cable 100 is connected to the earphone jack 11 so that an interface is necessary to match the data output from the USB cable 100 and the data processed by the portable telephone. For this reason, instead of the imaging interface 19b used in Embodiment 1-1, a USB interface 19c for converting data output from USB cable 100 and the data processed by the portable telephone 13 is provided in the interface section 119. When USB cable 100 is connected to the earphone jack 11, the switching section 125 connects output of earphone jack 11 to the USB interface 19c, and when the earphone microphone or stereo head phone is connected, the output of the earphone jack 11 is directed to the sound interface 19a.

Here, the switching section 125, upon detecting that the user has operated a certain function of the operation section 123, performing mode switching. For example, the switching section 125 carries out the process of discriminating the external device (a device connected to the earphone jack 11, in this case, USB cable 100). It is possible to automatically recognize an external device by inputting a specific signal output from an external device through the USB cable 100 and providing a further function to the switching section 125 to recognize the predetermined signal, which shows that the USB cable 100 is connected. In such a case, the specific signal should be a signal that has been predetermined for the portable telephone and the external device.

Next, the operation of the portable telephone 113 will be explained.

First, with the portable telephone 113 in the normal enabled state, the user inserts USB connector 101 into the earphone jack 11 of the portable telephone 113 to obtain electrical and mechanical connections. The current state is set to USB mode.

By so doing, a signal to report that the mode setting has been changed to USB mode is transmitted to CPU 126 of the portable telephone 113. CPU 126, recognizing that the mode setting has been changed to USB mode, determines whether USB cable is connected to the earphone jack 11. If the result indicates that such a connection has been made, CPU 126 outputs a signal to the switching section 126 to notify that USB mode is set, and the switching section 125 then selects USB interface 19c as the output interface for the earphone jack 11. When actual data transmission is commenced, the data input from the earphone jack 11 are output to the signal processing section 122 through the USB interface 19c, and the processing section 122 processes the input data, and the processed data are stored as necessary in RAM in the memory section 120.

On the other hand, when an instruction is given by the user to transmit the data from the operation section 123 of the portable telephone 113, the signal processing section 122 reads specified data from RAM or ROM of the memory section 120, and the readout data are output to USB cable through the USB interface 19c and the earphone jack 11. By so doing, required data can be transmitted to the external device through the USB cable.

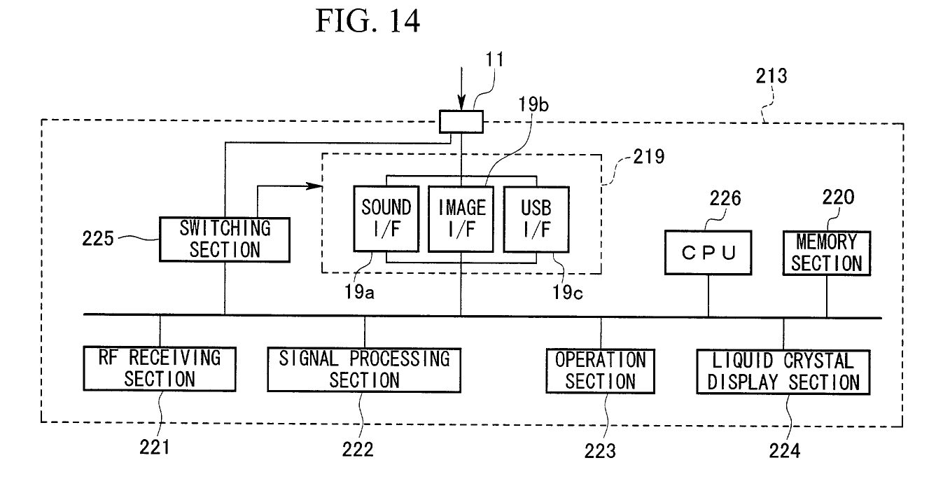

Next, a portable information terminal in Embodiment 1-3 will be explained. The portable information terminal in this embodiment has the function provided for the portable telephone 13 described in Embodiment 1-1 as well as the function provided for the portable telephone 113 described in Embodiment 1-2. That is, this portable information terminal is able to be connected to an earphone microphone, a stereo headphone, a digital camera 1 and a USB cable as external devices through the earphone jack 11. Therefore, the portable information terminal in this embodiment is provided with a sound interface 19a, an imaging interface 19b and a USB interface 19c in the interface section 219, as shown in FIG. 14, and these interfaces are switched according to the type of external device connected to the earphone jack 11. Accordingly, a portable information terminal of even higher convenience can be provided.

Next, a digital camera and a portable information terminal in Embodiment 2 will be explained. Here, a portable telephone (includes PHS) represents the portable information terminal.

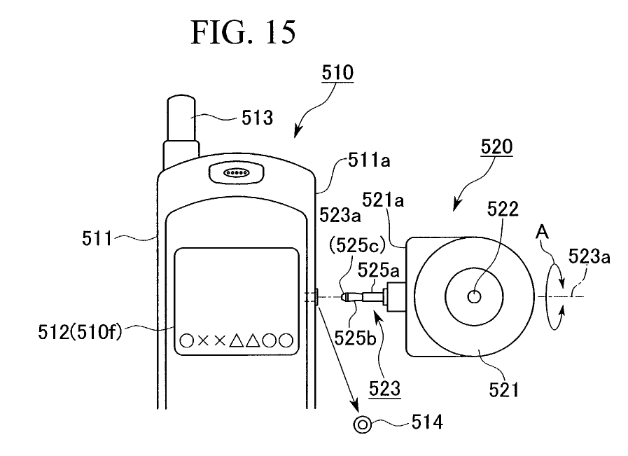

FIG. 15 shows an illustration of a portable information terminal and a digital camera in Embodiment 2. In this illustration, a reference numeral 510 relates to the portable telephone and a reference numeral 520 relates to the digital camera.

The digital camera 520 has a lens window 522 in the center section of the camera body 521, and a plug 523 protrudes from the bottom surface 521a that intersects the optical axis of the lens (not shown) inside the lens window 522, for example. The plug 523 has two contacts, a contact for transferring a clock signal 525a and a contact for transmitting data 525b. In addition to these two contacts, a third contact, a contact for receiving data 525c, may be provided.

The portable telephone 510 has a display section 510 such as a liquid crystal display on the telephone body 511, an antennae 513, a jack 514 on a side surface 511a. The jack 514 is provided with two contacts, one for receiving data and another for transferring a clock signal to correspond to the plug 523 of the digital camera 520 described above. In addition to these two contacts, a third contact, for transmitting data may be provided. Here, it is preferable that the earphone microphone jack provided on an existing portable telephone is used for the jack.

When the plug 523 of the digital camera 520 is inserted into the earphone jack 514 of the portable telephone 510, the contacts of the plug 523 and the jack 414 contact each other's corresponding contacts of the same kind at specific insertion locations to enable transfer of signals. Accordingly, a portable combined digital camera/information terminal system is provided comprising the portable telephone 510 and the digital camera 520 connected mechanically and electrically.

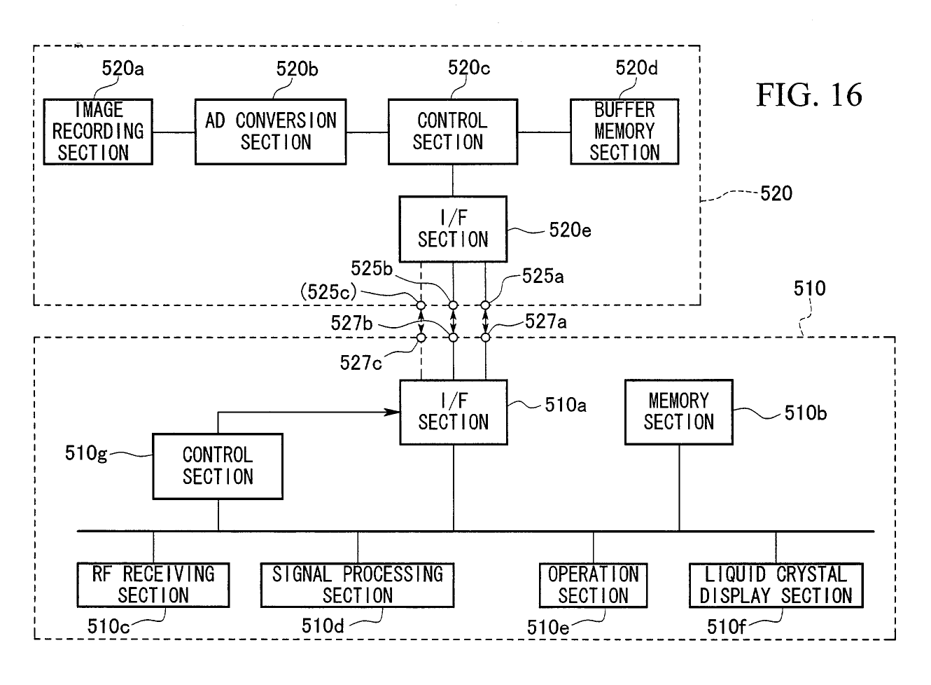

Next, the circuit configuration of the portable digital camera connecting apparatus will be explained with reference to FIG. 16.

As shown in FIG. 16, the portable telephone 510 is comprises an I/F interface section 510a for transferring data with an external device; a memory section 510b for storing various data; an RF processing section 510c for processing data through an antennae; a signal processing section 510d for processing transmit/receive signals; and an operation section 510e comprising a 10-key board and function keys and others to be operated by the user; a display section 512 served by a liquid crystal display section 510f; and a control section 510g for controlling various sections of the portable telephone 510; and further, a jack having a contact for transferring a clock signal 527a for transferring various data with the external device; and a contact for receiving data 527b for receiving data. Further, by providing a contact for transmitting data 527c for transmitting data in the earphone jack 514, data may be transmitted to the external device as required.

The control section 510 is structured as a logic circuit operated primarily by a microcomputer, and comprises CPU, ROM, RAM and the like. CPU executes certain computations according to predetermined programs. ROM stores control programs and control data required for executing various programs by CPU, and similarly RAM is used to temporarily store and output various data required for the CPU to execute various computations.

The digital camera 520 comprises an imaging section 520a having an imaging element such as CCD (charge coupled device); an AD conversion section 520b for converting image data produced by analog signals to digital signals; a control section 520c for controlling various sections of the digital camera 520 and processing image data; an I/F section 520e for transferring data to and from the buffer memory section 520d that stores image data, as well as to and from an externally connected device; a contact for transferring a clock signal 525a; and a contact for transmitting data 525b. The buffer memory 520d has a capacity to store one sheet of image, and the memory section 510b comprises a semiconductor memory and cards and the like.

The control section 520c is structured as a logic circuit operated primarily by a microcomputer, and comprises CPU, ROM, RAM and the like. CPU executes certain computations according to predetermined programs. ROM stores control programs and control data required for executing various programs by CPU, and similarly RAM is used to temporarily store and output various data required for the CPU to execute various computations.

Corresponding to the earphone jack 514 of the portable telephone, the plug 523 is constructed with two contacts, contact for transferring a clock signal 525a and a contact for transmitting data 525b, but by further providing a contact for receiving data 525c transmitted from an external device may be received.

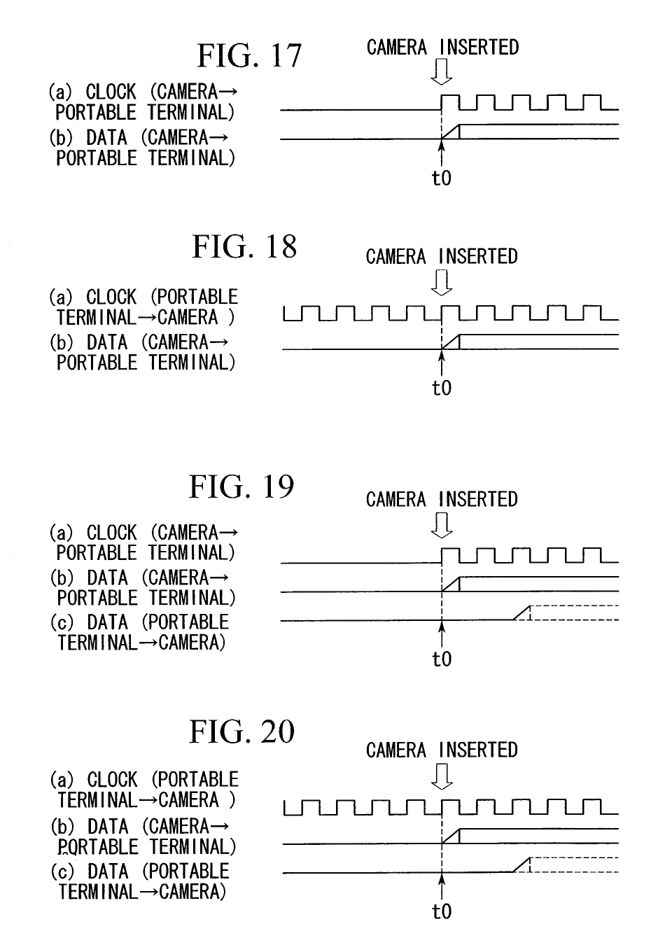

Next, when the plug of the digital camera 520 is inserted into the jack of the portable information terminal 510 thereby connecting the two electrically, the processes are carried out by both the portable information terminal 510 and the digital camera 520, which will be described with reference to FIGS. 17-21.

First, a case will be described with reference to FIGS. 17, 18, in which there are two contacts between the portable telephone and the digital camera 520, that is, the portable telephone 510 has the contact for transferring a clock signal 527a and the contact for receiving data 527b and the digital camera 520 has the contact for transferring a clock signal 525a and the contact for transmitting data 525b. In this case, two possibilities exist, one is to supply a clock signal from the digital camera 520 and other is to supply a clock signal from the portable telephone 510.

Digital Camera Supplies a Clock Signal

First, FIG. 17 shows a timing chart for a clock signal and corresponding output data when the portable telephone 510 and the digital camera 520 are electrically connected and the a clock signal is supplied from the digital camera 520 side to the portable telephone 510 side.

As shown in these diagrams, when the plug 523 of the digital camera 520 is connected at time t0 to the earphone jack 514 of the portable telephone 510 so that the two are connected electrically, the control section 520c inside the digital camera 520 outputs a clock signal from the contact for transferring the clock signal 525a (refer to FIG. 17A), and arbitrary data are output from the contact for transmitting data 525b (refer to FIG. 17B).

According to such a process, a clock signal is input in the control section 510g of the portable telephone 510 through the contact for transferring the clock signal 527 and the I/F section 510a, and arbitrary data are input through the contact for receiving data 527b and the I/F section 510a. In this case, arbitrary data refer to any random data, not to the data that are specifically prearranged between the digital camera and portable telephone.

Then, upon detecting the clock signal and data, the control section 510g determines that the external device being connected at this time is the digital camera 520, and the control section 510g stores image data output from the digital camera and input by way of the contact for transmitting data 525b, 527b in the memory section 510b inside the portable telephone 510, and displays the image received on the liquid crystal display section 510f.

Here, image data after being stored in the memory section 510f of the portable telephone 510 can freely be displayed on the liquid crystal display section 510f or deleted by the user performing certain operations using the operation section 510e.

Portable Telephone 510 Supplies a Clock Signal

Next, FIG. 18 shows a timing chart for a clock signal and corresponding output data when the portable telephone 510 and the digital camera 520 are electrically connected and the clock signal is supplied from the portable telephone 510 side to the digital camera 520 side.

As shown in these diagrams, when the plug 523 of the digital camera 520 is connected at time t0 to the earphone jack 514 of the portable telephone 510 so that the two are connected electrically, the control section 520c inside the digital camera 520 is supplied with a clock signal through the contact for transferring a clock signal 527a of the portable telephone 510 and the contact for transferring a clock signal 525a and the I/F section 520e of the digital camera (refer to FIG. 18A).

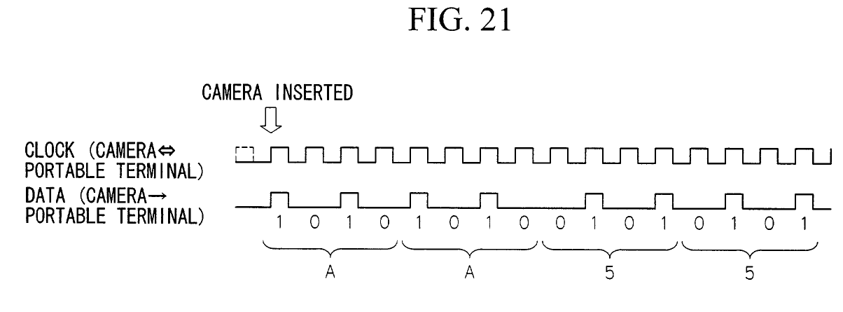

Upon receiving the clock signal, the control section 520c inside the digital camera 520 outputs data of predetermined format from the data line section 525a. For example, if “AA55” is set as such formatted data, the digital camera 520 outputs signals shown in FIG. 21 to the portable telephone 510 through the contact for transmitting data 525a. Specifically, the control section 520c outputs predetermined data in “AA55” format to the portable telephone 510 in synchronization with the input clock signal. Accordingly, data of a specific format is input into the portable telephone 510 through the data line section 527b and the I/F section 510a.

In the above description, predetermined data is not limited to 8-bit data described above, but may include any type of data so long as the data can be matched between the portable telephone 510 and the digital camera 520.

If the data obtained by the control section 510g is the predetermined data, the control section determines that the external device being connected at this time is the digital camera 520, stores image data transmitted from the digital camera 520 through the data line sections 525b, 527b in the memory section 510b of the portable telephone 510, and then displays received image data on the liquid crystal display section 510f.

Here, image data after being stored in the memory section 510b of the portable telephone 510 can be freely displayed on the liquid crystal display section 510f or deleted by the user performing certain operations using the operation section 510e.

On the other hand, when data different than the predetermined format is input or no data is input, it is determined that the external device being connected at this time is not the digital camera.

The next case will be an example in which the portable telephone 510 and the digital camera 520 are connected through three contacts. That is, the portable telephone 510 has a contact for transferring a clock signal 527a, a contact for receiving data 527b and a contact for transmitting data 527c, while the digital camera 520 has a contact for transferring a clock signal 525a, a contact for transmitting data 525b and the contact for receiving data 525c.

Similarly to the above embodiment, there are two ways of supplying a clock signal, i.e., the digital camera 520 side supplies the clock signal or the portable telephone 510 side supplies the clock signal.

Digital Camera Supplies a Clock Signal

FIG. 19 shows a timing chart for a clock signal and corresponding output data when the portable telephone and the digital camera are electrically connected and the a clock signal are supplied from the digital camera to the portable telephone.

As shown in these diagrams, when the earphone jack 514 of the portable telephone 510 is connected at time t0 to the plug 523 of the digital camera 520 so that the two are connected electrically, the contact for transferring a clock signal 520c inside the digital camera 520 outputs a clock signal from the contact for transferring a clock signal 525a (refer to FIG. 19A), arbitrary data is output from the contact for transmitting data 525b (refer to FIG. 19B).

According to such a process, a clock signal is input into the control section 510g of the portable telephone 510 through the contact for transferring a clock signal 527 and the I/F section 510a, and arbitrary data is input through the contact for receiving data 527b and the I/F section 510a. In this case, arbitrary data refer to any random data, not the data that have been pre-arranged between the digital camera and portable telephone.

When the control section 510g detects the clock signal and the data, it determines that the external device being connected at this time is the digital camera 520, and selects a circuit in the I/F section 510a to correspond to the image signals, and switches circuits.

When the imaging circuit is selected, operation keys and the like provided on the operation section 510e of the portable telephone 510 function as predetermined function keys for the digital camera 520.

When the user operates the operation section 510e as keys for the digital camera, the control section 510g transmits signals corresponding to the operation to the digital camera 520 through the contact for transmitting data 527c (refer to FIG. 19C). Then, the control section 520c inside the digital camera 520 can perform various processes corresponding to the operational data to execute the processes specified by the portable telephone 510 of the digital camera 520.

Portable Telephone 510 Supplies a Clock Signal

Next, FIG. 20 shows a timing chart for a clock signal and corresponding output data when the portable telephone and the digital camera are electrically connected and a clock signal is supplied from the portable telephone to the digital camera.

As shown in these diagrams, when the plug 523 of the digital camera 520 is connected at time t0 to the earphone jack 514 of the portable telephone 510 so that the two are connected electrically, the control section 520c inside the digital camera 520 is supplied with a clock signal through the contact for transferring a clock signal 527a of the portable telephone 510, the contact for transferring a clock signal 525a of the digital camera and the I/F section 520e (refer to FIG. 20A).

Upon receiving the clock signal, the control section 520c inside the digital camera 520 outputs data of predetermined format from the data line section 525a (Refer to FIG. 20B). For example, if “AA55” is selected as such formatted data, the digital camera 520 outputs signals shown in FIG. 21 to the portable telephone 510 through the contact for transmitting data 525a. Accordingly, data of a specific format is input into the portable telephone 510 through the data line section 527b and the I/F section 510a.

When the control section 510g determines the data, and if the data matches predetermined data, it determines that the external device being connected at this time is the digital camera 520, selects a circuit in the I/F section 510a to correspond to the image signals, and switches circuits.

When the imaging circuit is selected, operation keys and the like provided on the operation section 510e of the portable telephone 510 function as predetermined function keys for the digital camera 520.

Then, when the user operates the operation section 510e as keys for the digital camera, the control section 510g transmits signals corresponding to the operation to the digital camera 520 through the contact for transmitting data 527c (refer to FIG. 20C). Then, the control section 520c inside the digital camera 520 can perform various processes corresponding to the operational data to execute the processes specified by the portable telephone 510 of the digital camera 520.

On the other hand, when data different than the predetermined format is input or no data is input, it is determined that the external device being connected at this time is not the digital camera, and the control section 510g does not perform any specific processes.

Next, a portable information terminal and a digital camera for connecting to a portable information terminal in Embodiment 3 will be explained. this embodiment will be exemplified using a portable telephone (includes PHS) as a portable information terminal.

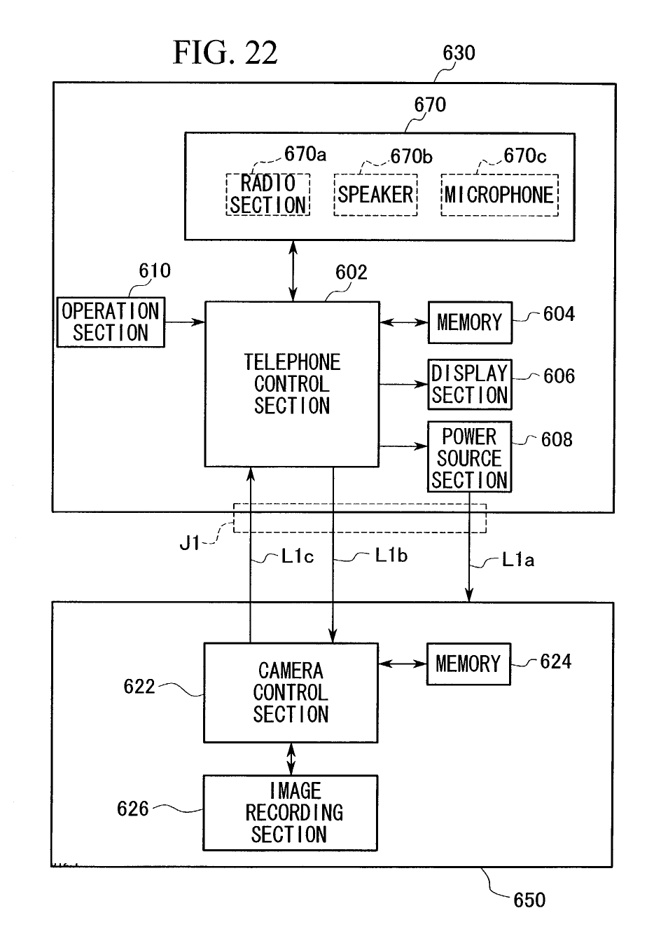

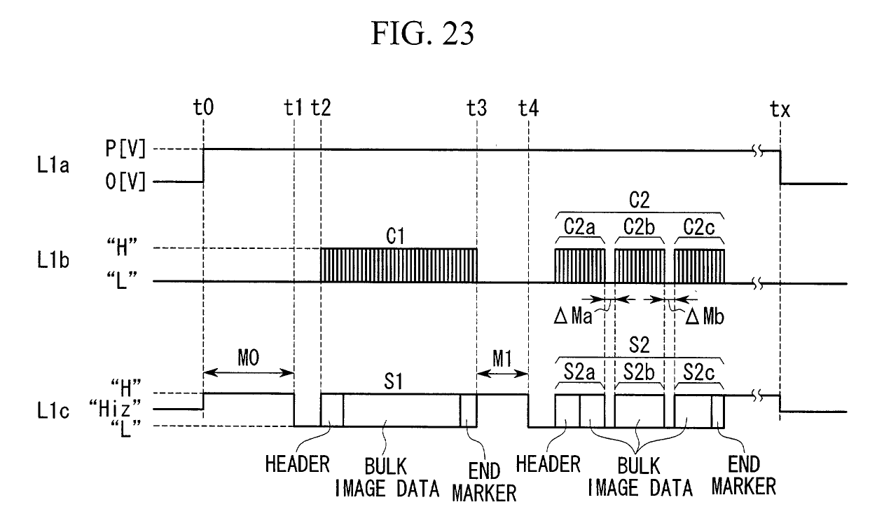

FIG. 22 shows a block diagram of the configuration of the portable information terminal and the digital camera for connecting to a portable information terminal.

In the diagram, the portable telephone 630 stores or displays as necessary image data received from the digital camera 650 though a specific signal line. On the other hand, the digital camera 650 is operated by the power supplied from the portable telephone 630, and transmits recorded image data to the portable telephone 630 through a specific signal line. The portable telephone 630 and the digital camera 650 are connected by signal lines L1a-L1c, which are: a power line L1a for supplying power from the portable telephone 630 to the digital camera 650; a data request signal line L1b for outputting a request signal for image data from the portable telephone 630 to the digital camera 650; and a data output signal line L1c for outputting (transmitting) a transmit-ready signal and image data from the digital camera 650 to the portable telephone 630. Here, the signal lines L1a˜L1c are connected to the earphone jack J1 of the portable telephone 630.

Next, the structure of the portable telephone 630 will be explained. The telephone control section 602 has a function (terminal detecting section) to detect a transmit-ready signal to show readiness for transmitting image data output from the digital camera 650 through the data output line L1c; a function L1b (terminal side output section) to output a transmit-request signal to the digital camera 650 through the data request signal line; and a function (receiving section) to receive image data transmitted from the digital camera 650 through the data output signal line L1c. Also, the telephone control section 602 controls on/off of power supplied to the digital camera 650 through the power line L1a. Further, the telephone control section 602 controls various section of the portable telephone 630. The telephone control section 602 comprises CPU, for example, and performs its functions by executing various programs for actualizing the function pre-stored in the memory section containing ROM and the like.

The memory section 604 is a memory for storing information related to various functions of the portable telephone 630, and stores telephone numbers according to telephone book function or image data received from the digital camera 650 under the control of the telephone control section 602.

The display section 606 displays operational states of various functions of the portable telephone 630, and displays for viewing as required, such information as telephone number of the transmitter and reception conditions at receiving times, residual battery power, and image data received from the digital camera 650.

The power section 608 supplies power to various sections of the digital camera 650 and its on/off function of the power is controlled by the action of the telephone control section 602.

The operation section 610 is used to execute various functions when using the phone or receiving image data from the digital camera 650, and is provided with alphanumeric keys for entering numbers and characters, and menu keys (not shown) to select various functions. Also, the radio section 670 is used to provide the telephone function for the portable telephone 630, and comprises a radio section 670a for processing radio signals, a speaker 670b, and a microphone 670c. The structure of the radio section 670 is the same as conventional portable telephone, and detailed explanations are omitted.

Next, the structure of the digital camera 650 will be explained. The camera control section 622 is provided with a function (camera side output section) to forward a transmit-ready signal to show that image data are ready to be transmitted to the portable telephone 630 through the data output signal line L1c; a function (camera side detection section) to detect a transmit-request signal to request image data to be transmitted from the portable telephone 630 through the data request signal line L1b; a function (transmitting section) to transmit image data to the portable telephone 630 through the data output signal line L1c. Also, the control section 622 controls various sections of the portable telephone 630. The camera control section 622 comprises a CPU, for example, and performs its function by executing various programs pre-stored in ROM and the like to actualize the functions of the camera control section 622.

The memory 624 stores image data recorded by the digital camera 650 successively, and the image data are stored successively as pictures, for example. Also, the imaging section 626 comprises imaging functions of the digital camera 650, and is provided with a lens and CCD (not shown) and the like, and records an image of the recording object under the direction of the camera control section 622. An image recorded by the imaging section 626 is processed by the camera control section 622, and is stored in the memory 624 as image data. Also, the digital camera 650 can record images automatically at given intervals under the direction of the camera control section 622, for example, and stores image data in the memory 624, and refreshes image data at given intervals.

Next, the process of transmitting image data from the digital camera 650 to the portable telephone 630 will be explained. FIG. 23 shows a timing chart for transmitting image data from the digital camera 650 to the portable telephone 630. Image data S1 is comprised by a bulk image data equivalent to one picture of the digital camera, a header and an end marker. In this diagram, when a specified source voltage P [V] is supplied from the portable telephone 630 to the digital camera 650 through the power line L1a (at time t0), the digital camera 650 begins its operation, and the camera control section 622 changes the state of the output signal line L1c from a high impedance state (Hiz) to the H(igh)-state. By so doing, the digital camera 650 informs portable telephone 630 that it is preparing to transmit image data. At this time, the camera control section 622 initializes each section of the digital camera 650, and then processes a first picture recorded by the imaging section 626 (includes the process of writing image data in the memory 624) (an interval M0). During the interval M0, the data output signal line L1c (1) is maintained in the H-state. When the above processing is finished, the camera control section 622 changes the data output signal line L1c to the L(ow)-state, where L section signal transmit-ready signal (time t1). By so doing, the portable telephone 630 is notified that image data transmitting preparation is completed.

The telephone control section 620 detects the L-state of the data output signal line L1c, and outputs a specific signal successively to the digital camera 650, through the data request signal line L1b (time t2). Such a signal may be a clock signal (transmitting request signal) C1 corresponding to a bit count of the image data S1. When clock signal C1 is not being output, the data request signal line L1b is normally set in the L-state by the telephone control section 602.

Responding to the clock signal C1, the camera control section 622 successively reads image data S1 stored in the memory 624 and outputs them to the data output signal line L1c. When image data S1 corresponding to one picture is output, the camera control section 622 returns the data output signal line L1c to the H-state (time t3), and informs the portable telephone 630 that it is in the image data transmitting preparation state. At this time, the camera control section 622 performs image processing of a second picture recorded by the imaging section 622 (includes writing image data for one picture into memory 624) (interval M1). When the above process is finished, the camera control section 622 changes the data output signal line L1c to the L-state (time t4). By so doing, the portable telephone 630 is notified that image data transmitting preparation is completed. Henceforth, the processes between t1-t4 are repeated, and image data are transferred as needed. Accordingly, the camera control section 622 transmits image data in picture terminals, and image data are output after the transmit-ready signal (L-state for the data output signal line L1c) is issued, in response to the clock signal from the telephone control section 602.

The telephone control section 602 successively receives image data output to the data output signal line L1c and writes the data into the memory 604, and when image data corresponding to one picture is written into the memory 604, the control section displays the image data on the display section 606 for viewing. Also, if the image data from the digital camera 650 are to be stopped, the telephone control section 602 stops supplying the specified source voltage P [V] to the digital camera 650 (time tx) to stop the operation of the digital camera 650 so as not to receive any more image data. By so doing, the portable telephone 630 does not supply power to the digital camera so that it is possible to prevent wasting the battery of the portable telephone 630.

On the other hand, if the portable telephone 630, for example, receives mail during image data reception, the telephone control section gives priority to mail reception so that transmitting of clock signal C2 is temporarily suspended (ΔMa, ΔMb), and the clock signal C2 is divided into clock signals C2a˜C2c and are output. In response to interruption of the clock signal C2, the camera control section 622 interrupts outputting of image data S2 (ΔMa, ΔMb). And, when outputting of clock signal C2 is resumed beginning with the clock signal (C2b and then C2c) that follows clock signal (C2a) that was transmitted just before the interruption, and in response, the camera control section 622 successively outputs image data S2 (S2b, S2c) that follows data (S2a) that was transmitted just before the interruption. According to this procedure, even when the telephone control section 602 interrupts outputting of clock signal C2 temporarily in order to perform a task other than image data acquisition, interrupted image data S2 can be received in continuation by resuming to output the clock signal C2.

Also, when the camera control section 622 renews (overwrites) the stored image data in the memory 624 at given intervals (0.2 seconds, for example) with the latest image data, if the interruption interval (ΔMa, ΔMb) becomes longer than the renewing interval of image data, then, during this interval, image data in the memory 624 are renewed by the latest image data. In such a case, a problem is created that the image data output from the camera control section 622 according to re-starting of outputting clock signal C2 by the telephone control section 602 are different than the image before the clock signal interruption. Therefore, in such a case, the camera control section 622 changes the data output signal line L1c to the H-state, and notifies the portable telephone 630 that it is in the image data transmitting preparation state. In the meantime, the telephone control section 602 detects a transmit-ready signal, and interrupts the process of re-starting reception of the interrupted image data S2 (re-starting clock signal C2 output). Then, when it detects a signal to show the transmitting allowed state (L-state of the data output line L1c), the telephone control section 602 is permitted to perform normal image data receiving process carried out during the interval t1-t4. By adopting such a procedure, it is possible to re-start image data reception without any difficulty, when the clock signal from the digital camera 650 has been interrupted longer than the image renewing interval of the digital camera 650.

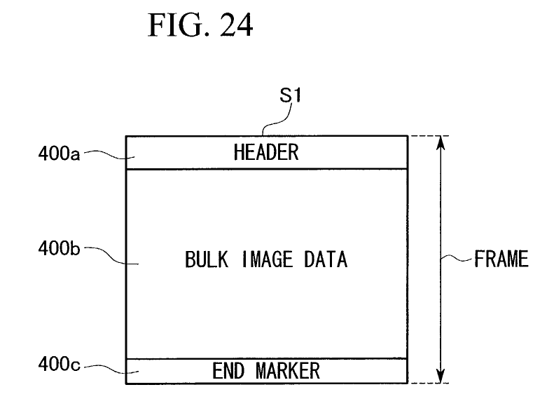

The structure of the image data (frame) will be explained with reference to FIG. 24. In this diagram, image data S1 is comprised by a bulk image data 400b equivalent to one picture recorded by the digital camera 650 and a header 400a containing attributes for one picture and an end marker 400c to show the tail end of the image data S1.

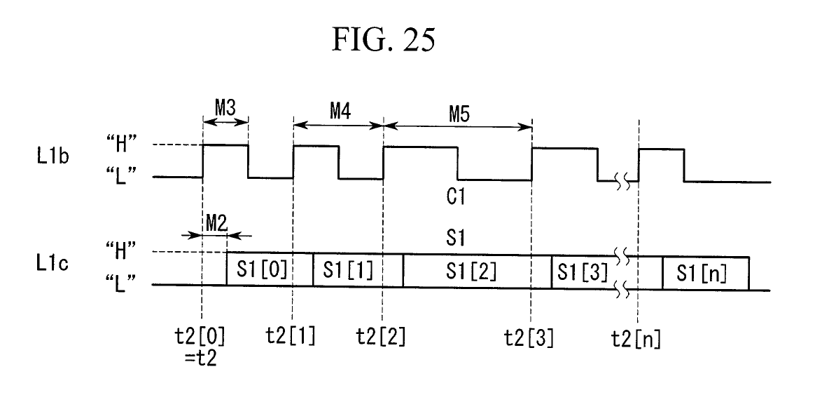

The relationship between a clock signal output and output timing of image data will be explained with reference to FIG. 25. In this diagram, each bit data that constitute image data S1, i.e., S1[0], S1[1], . . . S1[n], where n is an integer, is output in response to the rise instant t2[0](t2[0]=t2), t2[1], . . . t2[n] of clock signal C1. Also, an interval M2 is a time interval between the rise instant t2[n] of the clock signal C1 to the output time of each bit data S1[n] of image data S1, an interval M3 is the width of the clock signal C1 in the H-state, and an interval M4 (M5) is a period of one cycle of the clock signal C1 (frequency). Also, clock signal C1 is output at a constant interval, but the period may sometimes vary between M4-M5, depending on the processing state of the telephone control section 602. In such cases, output timing of bit data S1[n] of the image data S1 also varies accordingly (S1[1]-S1[2]).

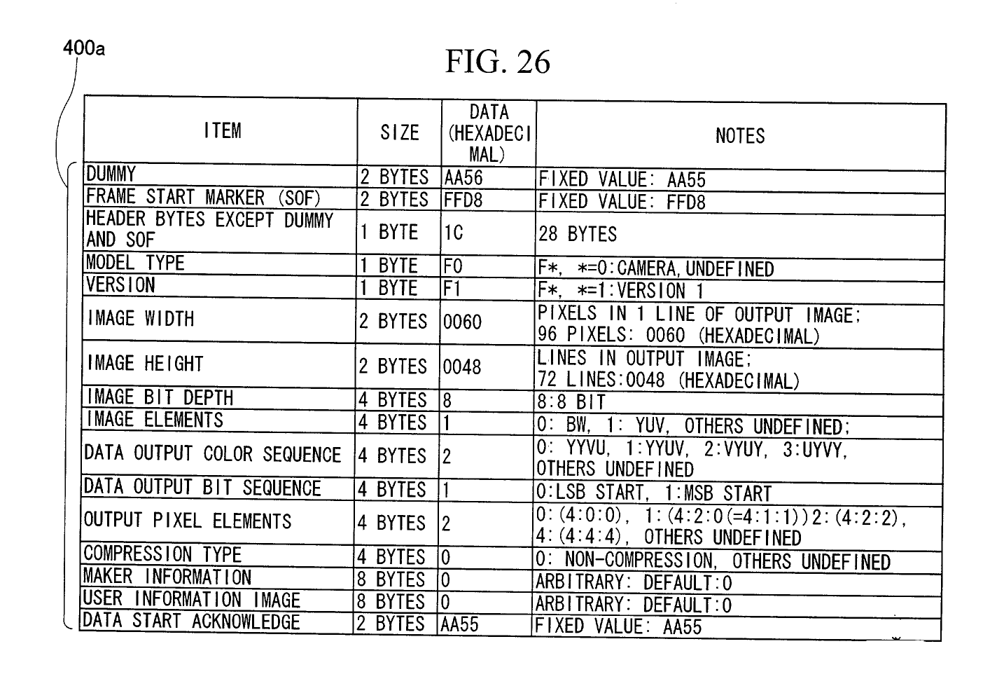

Here, the structure of the header 400a is as shown in FIG. 26. For example, the header 400a is comprised of 32 bytes to indicate such items as: ┌dummy┘ for detection of abnormality in the received data to be described later; ┌image data start acknowledge┘; bulk image data attributes such as ┌image width┘ and ┌image height┘ and the like.

Here, so long as the clock signal from the telephone control section 602 is not interrupted, the camera control section 622 transmits data for each item of the header 400a as a whole as image data S1 (FIG. 24). By so doing, handshake operation (steps for exchanging commands to confirm that transmitter and receiver are both in a state to begin transmit/receive operations), that has been necessary for each item of the header in the past, can now be performed in one step, so that the time required for handshake operation can be shortened.

Also, the telephone control section 602 is able to detect abnormality in the received image data by checking the items in the header 400a of the image data S1, such as ┌dummy┘ data and ┌image data start acknowledge┘ data with predetermined values. For example, if ┌dummy┘ data of the received image data is “552A” (hexadecimal), it is different than a fixed value “AA55” (hexadecimal) so that it is detected as abnormal.

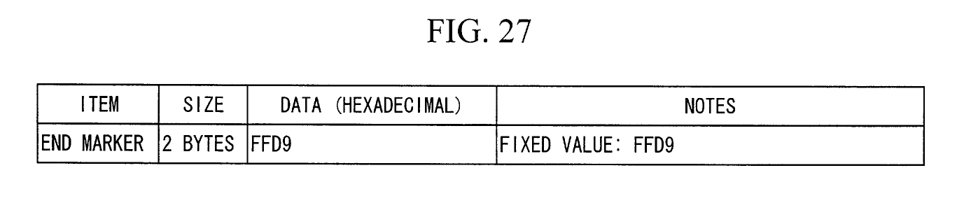

FIG. 27 shows an example of the data value of 2-byte end marker 400c. In this diagram, the end marker has its data value as “FFD9” (hexadecimal) and is the data to show the tail end of the image data S1.

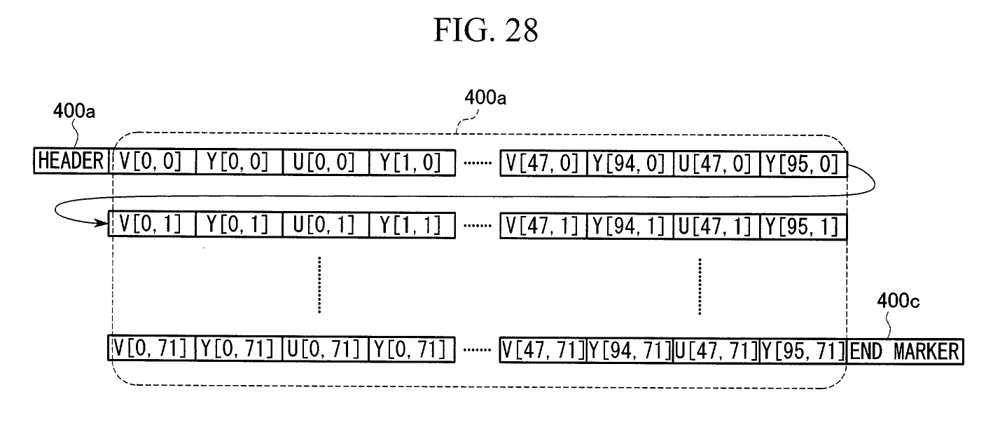

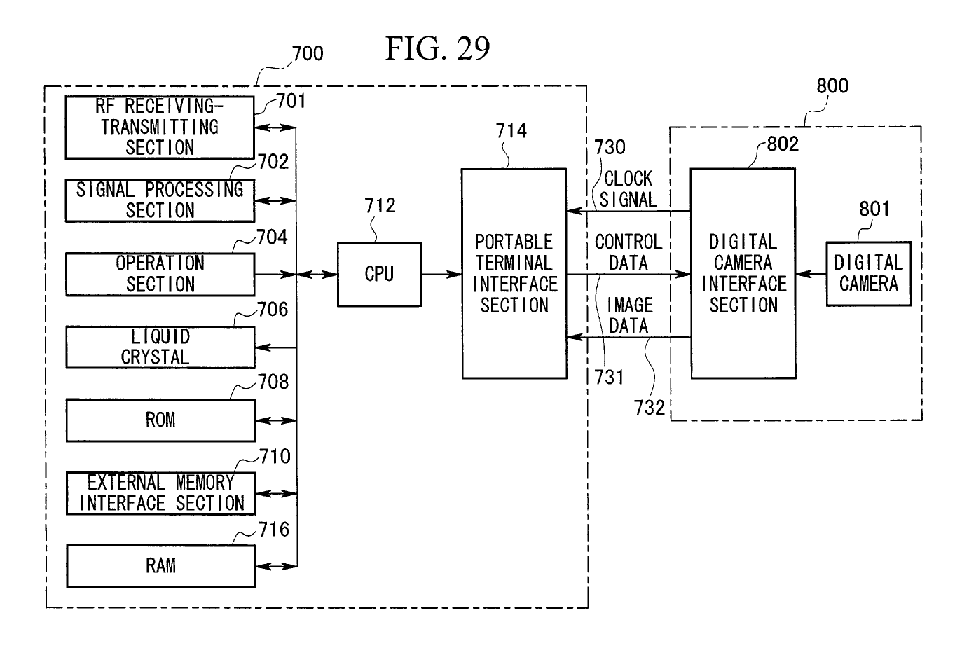

FIG. 28 shows an example of the output sequence of the image data S1. In this diagram, following the header 400c, bulk image data 400b are transmitted successively and the end marker 400c is transmitted last.

Here, the digital camera 650 in this embodiment may be mounted directly on the portable telephone 630 so as to terminal the two terminals. In such a case, there is no need for a connecting cable, and provides an advantage of convenience of use.

The above embodiment represent an example of the use of clock signal to request image data to be transmitted from the portable information terminal to the digital camera, but data transmission technique is not limited to this case. For example, after notifying the portable information terminal of readiness to transmit image data from the digital camera, image data may be transmitted at suitable times from the digital camera. By so doing, the data request signal line between the portable information terminal and the digital camera becomes unnecessary to facilitate mutual connectivity, and to enable to reduce manufacturing cost by reducing the signal lines for connectors and cables. Also, the contents of header and end marker comprising the image data (frames) may be varied suitably depending on the type, function and portability of the digital camera and portable information terminal.

Next, a portable information terminal in Embodiment 4 will be explained. Here, a portable telephone (includes PHS) is used as an example of the portable information terminal.

FIG. 29 shows an electrical configuration of the portable information terminal in this embodiment. In the diagram, portable telephone 700 comprises an antennae (not shown); an RF processing section 701 for processing sound signals and the like with the responding terminal through a base station; a signal processing section 702; an operation section 704 having various keys such as a ten-key section; a display section 706 for displaying various data; a ROM 708 for storing various programs and fixed data; a RAM 716; an external memory interface section 710; a CPU 712 for overall control of various sections; and a portable terminal interface section 714.

The signal processing section 702 is a circuit to perform functions such as encoding and decoding of sound signals, modulating received signals decoded in the RF processing section 701, outputting to a speaker (not shown), and encoding sound signals for sound call input from a microphone (not shown) and outputting to the RF processing section 701.

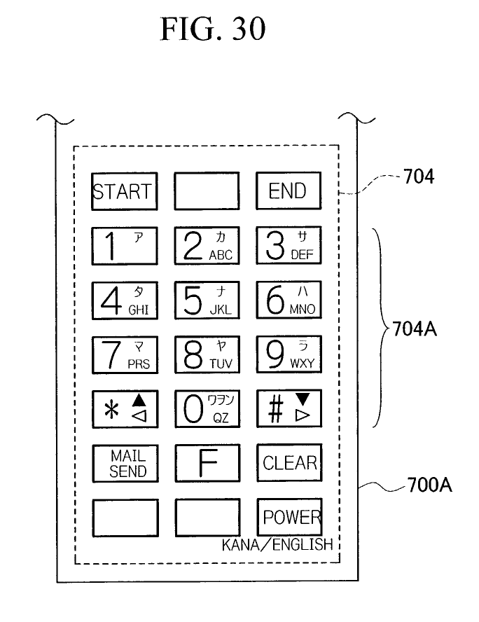

As shown in FIG. 30, the operation section 704 provided in the portable telephone body 700A is provided with various keys such as: a start key to receive a call; an end key to end a call; numeric keys (also for alphabets); a ten-key section 704A that includes #-key, *-key and other code keys; F-key for setting functions; a power-key for turning power on/off; a clear key for clearing settings; a mail-dispatch key for mailing request and others.

The display section 706 displays settings and menu information for providing telephone functions of the portable information terminal 700, and image information such as recording parameters to be used when the camera 800 is connected to the portable information terminal.

ROM 708 stores various programs for providing the telephone function and control programs as well as various fixed data.

RAM 716 stores temporary data processed by CPU 712 and various data input externally through the external memory interface section 710.

The camera 800 comprises a digital camera 801 and a digital camera interface section 802, and can be connected to the portable telephone 700 using the earphone jack provided conventionally for the portable telephone 700. FIG. 29 shows a block diagram of the portable telephone 700 connected to the camera 800, and the clock signal is supplied from the camera 800 to the portable telephone 700 side through the control line 730, and the control line 731 transmits control data from the portable telephone 700 side to the camera 800, and the signal line 732 transmits image data recorded by the digital camera 801.

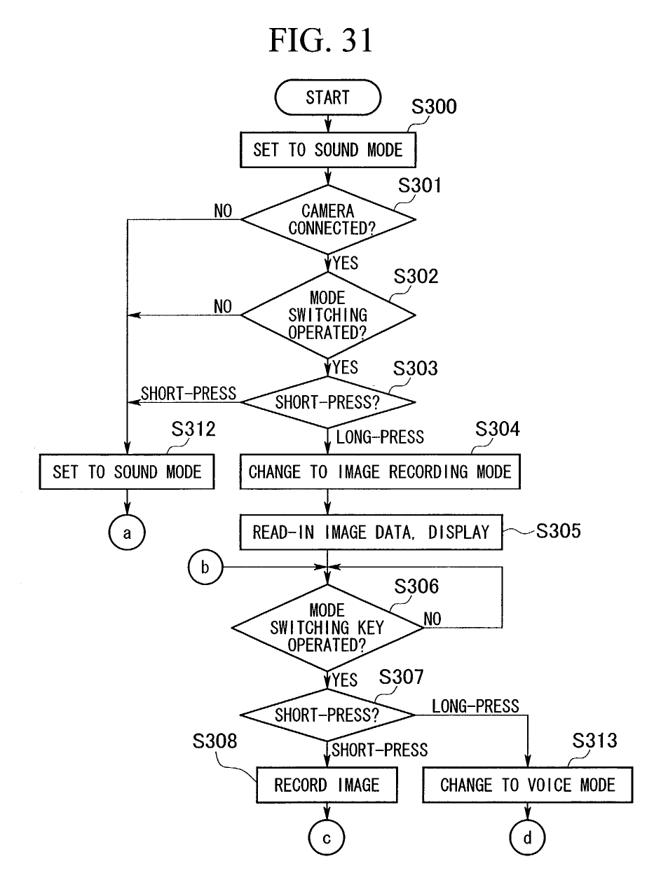

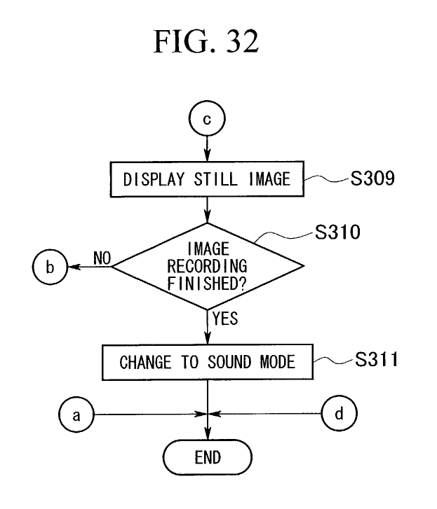

Control operations for switching the operational mode is performed by CPU 712, and this process will be explained with reference to the flowcharts shown in FIGS. 31, 32. The portable telephone 700 has two operational modes, sound mode and recording mode. The sound mode is the operational mode used when the portable telephone 700 operates as a telephone, and the recording mode enables image recording when the camera is connected to the portable telephone 700, by operating the keys of the operation section 704 of the portable telephone 700.

When the power key in the operation section 704 is operated, in FIGS. 31, 32, operational mode of the portable telephone 700 is set to the sound mode and the telephone function is enabled (step S300). Next, in step S301, it is determined whether the camera 800 is connected to the portable telephone 700. The discrimination process for the connection of camera 800 may be made by providing a detection device to detect the connection of connector to the earphone jack of the portable telephone 700, and a detection signal is accessed and used for the determination. Alternatively, the determination may be made according to whether a signal, to be output from the digital camera 801 of the camera 800 to the portable telephone 700 side through the digital camera interface section 802, has been output or not. It is of course permissible to use other methods.

If it is determined in step S301 that the camera 800 is not connected to the portable telephone 700, the flow advances to step S312, and the process is terminated leaving the setting in the sound mode.

If in step S301, it is determined that the camera 800 is connected to the portable telephone 700, then, in step S302, it is determined whether a key in the operations section 740 normally specified for communication function (telephone function in this embodiment) of the portable telephone 700 has been operated. In this embodiment, this key is assumed to be the F-key, for example.

The F-key is normally used in combination with numeric keys for a specific function of the telephone functions, but it is assumed in this case that the F-key is assigned for switching the sound mode to the recording mode when the camera 800 is connected to the portable telephone 700. If it is determined, in step S302, that the F-key as the mode switching key has been operated, and further in step S303, it is determined whether or not the F-key has been pressed for the long-press (that requires the key to be pressed for a specific duration). If it is determined, in step S302, that the F-key has not been operated, and in step S303, that the F-key has been pressed for the short-press (that requires the key to be pressed for a shorter duration than the specific duration), then the flow advanced to step S312, and the process is terminated with the setting remaining in the sound mode.

In step S303, if it is determined that the F-key has been pressed for the long-press the flow changes to the recording mode that permits the camera 800 to be operated by the keys in the operation section 704 of the portable telephone 700 (step S304). At this point, reflected light from the recording object is received in the recording section (not shown) of the digital camera 801, and is converted into image data in the recording section to correspond to the brightness of the recording object, and the image data of the recording object is output from the signal line 732 to the portable telephone 700 side, through the digital camera interface section 802, in synchronization with the clock signals output from the control line 730. CPU 712 accesses the image data through the portable terminal interface section 714, and transmits the image data to the display section 706.

The result is that the image based on the image data output from the digital camera 801 is displayed on the display section 706 of the portable telephone 700 (step S305). Continuing, in step S306, it is determined whether the F-key has been pressed for mode change. If it is determined, in step S306, that the F-key has been operated, it is determined in step S307 whether the F-key has been pressed for the short-press. If it is determined that the F-key has been pressed for the short-press, this key functions as the shutter key, and the digital camera 801 records an image of the recording object (step S308), and the recorded still image is displayed on the display section 706 (step S309).

On the other hand, if it is determined, in step S307, that the F-key has been pressed for the long-press, the mode is shifted from the recording mode to the sound mode (step S313), and the process is terminated. The state of the portable telephone 700 in the sound mode corresponds to a certain state demanded by a state of input-key. Here, a certain state relates to a state enabled by an input-key such as a start call operation, parameter settings for telephone function or data communication function, composing mails and telephone number entries.

After a still image recorded in step S309 is displayed on the display section 706, it is determined whether the recording process is finished (step S310). This determination may be based on assigning the finish-key in the operation section 704 as the end-recording key when the recording mode is active, and the determination is made according to whether or not the finish-key has been operated.

If it is determined, in step S310, that the recording process is finished, the flow changes to the sound mode (step S311), and this process is terminated. Or, if it is determined, in step S310, that the recording process is not finished, the flow returns to step S306, and the process described above is repeated.

Here, the portable information terminal in this embodiment may be operated in such a way that when a mail is received while the terminal is in the recording mode, the mode changes to the mail receive mode.

Also, in this embodiment, a certain key in the operation section 704 assigned normally to the telephone function is used as the mode switching key for switching between the sound mode and the recording mode when the camera 800 is connected to the portable telephone 700. Furthermore, when the terminal is in the recording mode, this key is used as a function key to provide functions related to recording operations, for example, the shutter key, however, instead of assigning only one key to functions related to recording operations, several different keys may be assigned to functions related to image recording.

Also, in this embodiment, shutter key is selected to represent a function related to image recording operations, but it is not limited to such a choice and the key may be assigned to perform other functions such as zoom operation or setting recording conditions.

Further, before or after changing to the recording mode, switching from the sound mode and the recording mode, or from the recording mode to the sound mode may be carried out by either the short-press method or the long-press method, so long as such an operation can be distinguished from other operations.

The present invention has been embodied by examples shown above with reference to the diagrams, however, specific structures are not limited to these examples, and designs without departing from the essence of the present invention are included.

For example, in Embodiments 1-1-1-4, portable telephone (includes PHS) was used to represent a preferred portable terminal device, but it is not limited to this case, so that any terminal is acceptable so long the terminal can be connected to portable personal computers, electronic notebooks and digital cameras.

According to a first aspect of the portable information terminal, two contact points are provided for transmitting and receiving data, and thus the connectors of a USP cable comprising the same structure can be connected. Thereby, carrying the conventionally required PC card is no longer necessary, and a useful portable information terminal can be provided. Furthermore, data communication between the portable information terminal and a personal computer becomes possible without using an insertion slot for a PC card, and thus other peripheral devices can be operation in parallel on the personal computer side.

According to a second aspect of the portable information terminal, a power supply contact and a ground contact are provided, and thus an external power supply becomes possible. As a result, the electrical consumption of the portable telephone can be reduced.

According to a third aspect of the portable information terminal, the contacts of the jack are arranged in order of, from an inner side towards an outer side of the terminal body, the data transmission-reception contact, other data transmission-reception contact, the ground contact, and the power supply contact, thus avoiding the problem of a poor contact even when a case section having a large contact area is rotated completely so as to serve as the voltage part. In addition, power shorting can be avoided because there is no nearby contact, even during partial insertion. In particular, the arrangement of the power supply contact and the ground contact conform to the arrangement of the earphone jack contacts, and thus there is the advantage of preventing trouble on the terminal side.

According to a fourth aspect of the portable information terminal, there is no need to provide a new connector for a USB cable connection because an earphone jack provided on any existing portable information terminal can be used as a data communication terminal. As a result, the effects can be attained that the miniaturization, lightening, and cost reduction of the portable communication terminal can be realized, and at the same time, a useful portable information terminal can be provided. In addition, because the earphone jack can be rotated 360 degrees, there is no need to confirm the orientation of the insertion when the USB connector is inserted, which is useful. Furthermore, because a lock mechanism is not provided, the lock can be released without worry.

According to a fifth aspect of the portable information terminal, in the jack terminal, the first data transfer contact namely data transmission-reception contact can be used as a data line contact and the second data transfer contact namely data transmission-reception contact can be used as a clock line contact, and thus the earphone microphone can be used to transfer image data produced by the digital camera, which contributes to making possible a multi-purpose portable information terminal. Thereby, the effect is attained that a portable information terminal can be provided that is responsive to the diversification of the user's needs and has a high usability.

According to an sixth aspect of the portable information terminal, a circuit switching section that connects the jack to a sound circuit or a data processing circuit is provided, and thus, depending of the external devices connected to the jack, the circuit that handles the input and output data is switched, and thereby data processing appropriate to the external devices can be carried out. Thereby, even with external devices that process different data, a connection can be made using one jack.

According to a seventh aspect of the portable information terminal, when the connecting of a USB cable has been detected, the switching circuit automatically switches the contact destination of the earphone jack depending on the connected device, and thus processing according to the various data output from the earphone jack can be carried out.

According to an eighth aspect of the portable information terminal, a jack is provided that has four contacts for a power supply, a ground, transferring a clock signal and transferring data, and thus by inserting the plug of the digital camera into the jack, it can be installed by being directly connected mechanically and electrically. Thereby, a power supply can be received from the portable information terminal, image recording carried out, and the recorded images can be sent to the portable information terminal.

According to a ninth aspect of the portable information terminal, the contacts of the jack are arranged in order of, from an inner side toward an outer side of the terminal body, the contact for transferring data, the contact for transferring the clock signal, the contact for the ground, and the contact for the power supply, thus avoiding the problem of poor contact even when a case section having a large contact area is rotated completely so as to serve as the voltage part. In addition, power shorting can be avoided because there is no nearby contact, even during partial insertion. In the case of an earphone microphone, the contact for the ground is second from the base section so that problems in the terminal can be prevented.

According to a tenth aspect of the portable information terminal, the jack can be used as an earphone jack, and thus because an earphone jack on any existing portable information terminal can be used as a terminal for data communication, there is no need to provide a new jack for connecting the digital camera. As a result, the effects can be attained that the miniaturization, lightening, and cost reduction of the portable communication device can be realized, and at the same time, a useful portable information terminal can be provided.

According to an eleventh aspect of the portable information device, because the switching section is provided that selects either a sound circuit or an imaging circuit according a signal input into the jack and then connects the selected circuit to the jack, image recording can be started simply by connecting the digital camera.

According to a twelfth aspect of the portable information terminal, when the plug is electrically connected to the jack, the circuit switching section measures the resistance between predetermined terminals of the plugs, and thereby the connected device is identified. Thereby, the connected devices can be identified using a simple circuit structure.

According to a thirteenth aspect of a digital camera for a portable information terminal, in a digital camera connected to the portable information terminal that provides jacks for sound input and output, a digital camera body is provided and plugs are provided arranged so as to be substantially perpendicular to the optical axis of the lens of the digital camera, and structured so that when the plug is inserted onto the jack of the portable information terminal, the digital camera body pivots on the axis of the plug. In addition, when the digital camera according to the present invention is connected to the portable information terminal, because the direction of image recording can be freely adjusted, a digital camera that is easy to handle can be realized. Furthermore, because any jack that is already installed on the portable information terminal can be used to form a connection, the effects are attained that there is no need to provide a separate way to receive the connection terminal, and an inexpensive product can be provided. In addition, because the digital camera body is integrated with the portable information terminal, image recording can be carried out with one hand, and convenience is improved.

Furthermore According to this structure, the effects are attained that the connection angle of the plug can be arbitrarily selected over 360 degrees by the axial cross-section of the plug being made circular, and furthermore, the angle can be adjusted by rotating the axis of the plug in the connected state on the center.

According to a fourteenth aspect of a digital camera for a portable information terminal, because of providing plugs arranged so as to be substantially perpendicular to the optical axis of the lens of the digital camera, when the jack, which is generally provided on the lateral surface of the portable information terminal, is connected to the plug, the effect is attained that an optimal camera position can be easily set in order to record images while observing the display section of the portable information terminal.

According to a fiftheenth aspect of the digital camera for a portable information terminal, a switching section is provided in either the digital camera body or the portable information terminal for switching between a sound circuit and an imaging circuit, and when the jack and plug are connected electrically, image data are transferred from the digital camera side to the portable information terminal by way of the plug and jack, and thus the operation of the complicated initial settings becomes unnecessary. As a result, the effect is attained that simply be connecting the digital camera, image recording can be immediately started.

According to a sixteenth aspect of the digital camera for a portable information terminal, a mound section is provided around a periphery of the plug of the digital camera body, so that, when the plug is inserted into the jack, the mound section is abutted against the periphery of the jack, and when the digital camera is rotated, a surface of the mound section is made to slide against the periphery of the jack, and thereby the digital camera can be readily rotated by sliding against the portable information terminal.

According to a seventeenth aspect of the digital camera for a portable information terminal, a plug is formed so as to provide four contacts for a power supply, a ground, transferring a clock signal, and transferring data, and thereby the digital camera can be operated using the power supplied from the portable information terminal and transmit the recorded image data to the portable information terminal. As a result, because a device that supplies power in the digital camera body is not necessary, the cost can be reduced, the weight decreased, and miniaturization implemented.

According to an eighteenth aspect of the digital camera for a portable information terminal, the four contacts arranged in order of, starting from a base section of the digital camera body side, the contact for power supply, the contact for the ground, the contact for transferring the clock signal, and the contact for transferring the data, and thus even when the case section that has a large contact area serves as the contact for power supply, the problem of improper contact can be avoided even when it is rotated completely. In addition, when the plug is only partially inserted, the effects are attained that shorting can be avoided because there are no nearby terminals. Furthermore, in the case of an earphone microphone, the contact for the ground is second from the base section so that trouble in the terminal side can be prevented.

According to a nineteenth aspect of the digital camera for a portable information terminal, the contact for ground and the contact for transferring the clock signal of the plug are electrically isolated. According to this structure, by detecting the resistance between the contacts, the portable information terminal, which is the connection destination, can be notified that a digital camera is connected. As a result, the portable information terminal can be easily notified by a simple circuit structure about the case of another plug being connected and the case of the digital camera being connected, and thus the cost can be reduced and miniaturization implemented.

According to a twentieth aspect of the digital camera for a portable information terminal, an insertion section is provided and thus after threading a string through this insertion section into a strap hole provided in advance in the portable information terminal, the digital camera and the portable information body can be combined to facilitate carrying by conjoining the ends of the string.

According to a twenty first aspect of the digital camera for a portable information device, a movable member which supports the plug so as to be movable with the plug; and a guide section which supports the movable member so as to be freely movable along a longitudinal axis of the plug and to enable the plug to be housed in the digital camera body are provided, and thus the plug can be accommodated in the body to facilitate portability.

According to a twenty second aspect of the digital camera for a portable information device, a lens cover is provided for protecting the lens of the digital camera, and the lens cover is detachable from the lens by moving it with the movable member, and thereby the plug can be accommodated in the digital camera body, and at the same time, the lens can be covered with the cover, and the lens can be protected from dust and impact.

According to a twenty third aspect of the digital camera connected to a portable information device, there are the effects that determining the type of external devices, such as the digital camera, being connected to the portable information terminal becomes possible by connecting a digital camera and a portable information terminal having mutually corresponding connection points, and in addition, an arbitrary image can be displayed on the display section of the portable information terminal by sending image data to the portable information terminal. In addition, because the digital camera for the portable information terminal is directly mounted on the portable information terminal, the effects are attained that a cable for connection becomes unnecessary, and the digital camera is easy to handle. In addition, because the earphone jack on the existing portable information terminal can be used as-is as a jack connected to the digital camera, a dedicated terminal does not have to be specially provided, and the cost can be reduced.

According to a twenty fourth aspect of the portable information terminal, a contact for transmitting image data of a plug of a digital camera electrically connected to the contact for receiving data and a contact for transferring a clock signal of the plug of the digital camera connected to the contact of transferring the clock signal are provided, and thereby image data from the digital camera can be simply input into a portable telephone, and furthermore, the contact for receiving data and the contact for transferring a clock signal can use the earphone jack provided in any conventional portable telephone, and thus providing a new dedicated terminal is not necessary, the device can be miniaturized, and the cost can be reduced.

According to a twenty fifth aspect of the portable information terminal, further comprising a contact for transmitting data is provided, and thereby, because bi-directional data communication with the connected devices becomes possible, enriching the functions of the portable information device can be implemented, and there is the effect that added value is accrued. In addition, the earphone jacks provided on any conventional portable information terminals have four channels, and thus even if the contact for transmitting data, as described above, has three contacts, because using this earphone jack in common is sufficient, the transmission and reception of data without using a high cost interface, for example, becomes possible. Thereby, miniaturization and cost reduction of the device can be realized.

According to a twenty sixth aspect of the portable information terminal, in the case that a clock signal is input into a contact for transferring, a first digital camera connection recognition device is provided that recognizes that the digital camera is connected. Thereby, during input from the external devices, when the clock is input, there are the effects that determination of whether the external device is a digital camera can be easily carried out, and the digital camera can be easily connected by using the connection terminal normally provided on the portable information terminal.

According to a twenty seventh aspect of the portable information terminal, a control section starts generating a clock signal to a external device way of the contact for transferring a clock signal of the terminal to a clock signal of the external device in the case that the external device is connected, and subsequently, in the case that the first data line section receives predetermined data, a second digital camera connection recognition device that recognizes that a digital camera is connected is provided, and thus, external devices can be easily identified, and the portable information terminal can be formed by a simple circuit.

According to a twenty eighth aspect of the digital camera for a portable information terminal, because only two contacts comprising a contact for transmitting data and a contact for transferring a clock signal are provided, so long as the connected device two contacts, data transfer becomes possible, and thus the image data can be transmitted to the connected device in a simple manner without using a complex interface and the like. As a result, an expensive interface, etc., need not be provided, and miniaturization and cost reduction can be realized.

According to a twenty ninth aspect of the digital camera for a portable information terminal, because a contact for receiving data is further provided, reception of data becomes possible, and for example, operating the digital camera from a device being connected to the connection destination becomes possible. Thereby, a digital camera having a high added value can be realized.

According to a thirtieth aspect of the digital camera for a portable information terminal, because a control section starts generating a clock signal and outputs the clock dignal to an external device in the case that an external device is connected, whether the digital camera is connected can be easily determined with respect to the device at the connection end/destination, and thus can be made without using an expensive interface and with a simple circuit structure.

According to a thirty first aspect of the digital camera for a portable information device, because when the control section receives the clock signal by way of the contact for transferring the clock signal, the control section outputs predetermined data through the contact for transmitting data, and thereby whether the digital camera is connected with respect to the devices at the connection destination can be easily recognized, and can be made without using an expensive interface and with a simple circuit structure.

According to a thirty second aspect of the portable information device connected to a digital camera, the above-described portable information terminal is connected to the digital camera, and thus identifying the type of the external device, such as the digital camera, connected to the portable information terminal can be simply realized. In addition, in the case that unidirectional communication is carried out, the number of terminals is two, and when bi-directional communication is carried out, the number of terminals is three. However, in either case, because the earphone jack provided on existing portable information terminals can be used, a low cost connection between the portable information terminal and the digital camera can be realized, and at the same time, the design cycle can be shortened. In addition, because the transmission and reception of data is possible using the earphone jack, compared to the case of carrying out transmission and reception of data using, for example, infrared light and ES-232, there will be no complexities related to directionality and cables, and the use environment for the user can be made pleasant.

According to a thirty third aspect of the portable information terminal, the portable information terminal (portable telephone) detects a transmission-ready state of the image data that is transmitted from the digital camera, and receives the image data sent from the digital camera based on this transmission, and thus carrying out the conformation (handshake) of the transmission start by transmitting and receiving a predetermined command between each other, as is done conventionally, is unnecessary, and the image data can be transmitted quickly to the portable information terminal.

According to a thirty fourth aspect of the portable information terminal, the portable information terminal detects an abnormality during reception of the image data based on the reception abnormality identification signal (information in the header) included in the received image data, and thus errors in which image data that has been abnormally received being input and displayed in the portable information terminal can be prevented.

According to a thirty fifth aspect of the portable information terminal, by using a transmission preparation signal, the portable information terminal notifies the digital camera that the image data is in a transmission-ready state, and thus image data can be input when conditions are good relative to the operational state of the portable information terminal.

According to a thirty-sixth aspect of the portable information terminal, all the image data from the digital camera can be received at once, and thus image data can be sent altogether, and not divided into small packets of data (of one byte units), as is done conventionally, and thus the portable information terminal can receive data quickly and efficiently.

According to a thirty-seventh aspect of the digital camera for a portable information terminal, the conventional handshake operations can be carried out altogether at one time, and thus the effect is attained that the time for the handshake operation can be reduced. In addition, after the portable information terminal has been notified that the image data from the digital camera is in a transmission-ready state, because the image data is sent from the digital camera as appropriate, the data request signal line between the portable information terminal and the digital camera becomes unnecessary, the interconnection is further simplified, and at the same time, the production cost is reduced by the number of signal lines of the contacts and cables for these connections is reduced.

According to a thirty-eighth aspect of the digital camera for a portable information terminal, a camera side detection means is provided that detects the transmission request signal requesting transmission of the image data with notification by the digital camera, and in the case that the camera side detection means detects a transmission request signal after the camera side output means outputs a transmission preparation signal, the transmission means transmits the image data to the portable information terminal, and thus, the effect is attained that image data is sent when the conditions are good relative to the operational state of the portable information terminal.

According to the thirty-ninth aspect of the portable information terminal connected to a digital camera, the digital camera for the portable information terminal is directly mounted on the portable information terminal, and thus a cable for connection becomes unnecessary, and the advantage of ease of handling is attained.

According to a fortieth aspect of the control method for a portable information terminal, providing keys dedicated to image recording functions becomes unnecessary, a small number of keys necessary for operation during image recording are sufficient, and it becomes unnecessary to carry out the operation of confirming one by one on the screen in the display device in order to carry out the switching to image recording-ready state and the image recording operation. Therefore, because the keys dedicated to the image recording function are unnecessary, the portable information terminal can be formed compactly. In addition, a small number of keys necessary for operation during image recording are sufficient, and thus errors in key operation are eliminated, and the operation becomes simple. Furthermore, the operation of confirming one by one on the screen of the display section in order to carry out switching to a image recording-ready state and the image recording operation becomes unnecessary, and thus the complication of confirming the setting state while watching the screen of the display section and at the same time operating keys is eliminated.

According to a forty first aspect of the control method for a portable information terminal, the camera is set to a image recording-ready state, and in the case that any one of the plurality of keys in the operation section in this state is operated by being pressed down for a time shorter than the above-described constant time, an operation corresponding to the image recording function of the camera assigned to the keys that are operated under the image recording-ready state is executed, and in the case that any among the plurality of keys in the operation section is operated by being pressed for a long time, control is carried out such that the predetermined key input state of the portable information terminal shifts, and thus switching between the transmission-ready operation mode (communication mode) and the image recording-ready operation mode (image recording mode) becomes easy, and can be used by the user comfortably.

According to a forty second aspect of the control method for a portable information terminal, under the condition that the camera is connected to the portable information terminal, in the case that an operation is carried out in which a particular key among a plurality of keys in the operation section of the portable information terminal is continuously pressed down more than a certain time, the camera switches to a image recording-ready state, and in this state, furthermore, in the case that a particular key is operated, an operation corresponding to the image recording function of the camera assigned to the key is executed, and thus by operating one key, switching between communication mode and image recording mode is possible, errors in key operation are eliminated, and the operation becomes simple.

In addition, switching to a image recording-ready state and image recording operation can be carried out using one key, and thus carrying out operations while confirming one by one on the screen of the display section becomes unnecessary, and the complexity of operating keys by confirming the setting state while watching the screen of the display section is eliminated.

According to a forty third aspect of the portable information terminal, an operation means is provided that has a plurality of keys and a control means is provided in which, under the condition that the camera is connected to the portable information terminal, in the case that an operation is carried out in which a particular key among a plurality of keys in the operation section is pressed down continuously more than a certain time, the camera switches to the image recording-ready state, and under this state, furthermore, in the case that one or a plurality of keys among a plurality of keys in the operation section are operated, the operation corresponding to the image recording function of the camera assigned to the key is executed, and thus providing keys dedicated to image recording function is unnecessary, a small number of keys needed for operation during image recording is sufficient, and it becomes unnecessary to carry out the operation of confirming one by one on the screen in the display device in order to carry out the switching to image recording-ready state and the image recording operation. In addition, because a small number of keys needed for operation during image recording is sufficient, errors in the key operation are eliminated, and the operation becomes simple. Furthermore, the operation of confirming one by one on the screen of the display section in order to carry out switching to the image recording-ready state and the image recording operation becomes unnecessary, and thus the complexity of the operation of confirming the setting state while watching the screen of the display section is eliminated.

According to an forty fifth aspect of the portable information terminal, the control section sets the camera to the image recording-ready state, and control is carried out such that in the case that an operation is carried out in which a key among the plurality of keys in the operation section under this condition is pressed down a shorter time than a constant time, an operation corresponding to the image recording function of a camera assigned to an operated key is executed, and in the case that an operation is carried out in which a key among a plurality of keys in the operation section is pressed for a long time, a predetermined key input state of the portable information terminal is shifted to, and thus switching between the communication-ready operation state (communication mode) and the image recording-ready operation state (image recording mode) becomes easy, and can be used by the user comfortably.

According to an eighty-second aspect of the portable information terminal, an operation section is provided that has a plurality of keys and a control section is provided in which, under the state that the camera is connected to the portable information terminal, in the case that an operation is carried out in which a particular key among a plurality of keys in the operation section of the portable information terminal is pressed down continuously for more than a certain time, the camera switches to the image recording-ready mode, and under this state, furthermore, in the case that a particular key is operated, an operation corresponding to the image recording function of the camera assigned to the key is executed, and thus switching between the communication mode and the image recording mode can be carried out by operating one key, errors in key operation are eliminated, and the operation becomes simple. In addition, the switching to the image recording-ready state and the image recording operation can be carried out with one key, and thus operating while confirming one by one on the screen of the display section becomes unnecessary, and the complications of operating keys by confirming the setting state while watching the screen on the display section is eliminated.

1. A portable information terminal, comprising a jack having a first and a second transfer contacts for transmitting-receiving data.

2. A portable information terminal according to claim 1, wherein the jack further comprises a power supply contact and a ground contact.

3. A portable information terminal according to claim 2 further comprising a terminal body having an inner side and an outer side, wherein the contacts of the jack are arranged from the inner side toward the outer side of the terminal body in the following order, (i) the first data transfer contact, (ii) the second data transfer contact, (iii) the ground contact and (iv) the power supply contact.

4. A portable information terminal according to claim 1, wherein the jack is configured to be used with an earphone jack.

5. A portable information terminal according to claim 2, wherein the jack is configured to be used with an earphone jack.

6. A portable information terminal according to claim 3, wherein the jack is configured to be used with an earphone jack.

7. A portable information terminal according to claim 1, wherein the first data transfer contact is configured to be used for data line, and the second data transfer contact is configured to be used for a clock signal line.

8. A portable information terminal according to claim 2, wherein the first data transfer contact is configured to be used for data line, and the second data transfer contact is configured to be used for a clock signal line.

9. A portable information terminal according to claim 3, wherein the first data transfer contact is configured to be used for data line, and the second data transfer contact is configured to be used for a clock signal line.

10. A portable information terminal according to claim 4, wherein the first data transfer contact is configured to be used for data line, and the second data transfer contact is configured to be used for a clock signal line.

11. A portable information terminal according to claim 1, further comprising a circuit switching section which connects the jack to one of a sound circuit and a data processing circuit.

12. A portable information terminal according to claim 2, further comprising a circuit switching section which connects the jack to one of a sound circuit and a data processing circuit.

13. A portable information terminal according to claim 3, further comprising a circuit switching section which connects the jack to one of a sound circuit and a data processing circuit.

14. A portable information terminal according to claim 4, further comprising a circuit switching section which connects the jack to one of a sound circuit and a data processing circuit.

15. A portable information terminal according to claim 7, further comprising a circuit switching section which connects the jack to one of a sound circuit and a data processing circuit.

16. A portable information terminal according to claim 11, wherein the circuit switching section connects the jack to the data processing circuit when information relating to data transfer start is input to the circuit switching section.

17. A portable information terminal, comprising a jack having a power supply contact, a ground contact, a clock signal transferring contact and a data transferring contact.

18. A portable information terminal according to claim 17 further comprising a terminal body having an inner side and an outer side, wherein said contacts of the jack are arranged from the inner side toward the outer side of the terminal body in the following order (i) the data transferring contact, (ii) the clock signal transferring contact, (iii) the ground contact, and (iv) the power supply contact.

19. A portable information terminal according to claim 17, wherein the jack is configured to be used with an earphone jack.

20. A portable information terminal according to claim 18, wherein the jack is configured to be used with an earphone jack.

21. A portable information terminal according to claim 17 further comprising a circuit switching section selecting one of a sound circuit and an imaging circuit according to a signal input into the jack and then connecting the selected circuit to the jack.

22. A portable information terminal according to claim 18 further comprising a circuit switching section selecting one of a sound circuit and an imaging circuit according to a signal input into the jack and then connecting the selected circuit to the jack.

23. A portable information terminal according to claim 19 further comprising a circuit switching section selecting one of a sound circuit and an imaging circuit according to a signal input into the jack and then connecting the selected circuit to the jack.

24. A portable information terminal according to claim 21, wherein, when a plug of an external device is connected to the jack, the circuit switching section identifies the connected external device by measuring an electrical resistance between predetermined contacts of the plug.

25 A digital camera for a portable information terminal configured to be connected to said digital camera
said portable information terminal comprising a jack for input/output of signals including sound signals, and
said digital camera comprising a digital camera body having a plug for detachably connecting to the jack, wherein the plug has a circular transverse cross-sectional shape.

26. A digital camera for the portable information terminal according to claim 25, wherein said plug further comprises a tip end and said digital camera further comprises a lens and wherein the plug is disposed so that said tip end is substantially perpendicular to an optical axis of said lens.

27. A digital camera for the portable information terminal according to claim 25, wherein a circuit switching section is provided in one of the digital camera body and the portable information terminal, said circuit switching section switching between a sound circuit and an imaging circuit, and wherein when the jack and the plug are connected electrically, image data is transferred from the digital camera to the portable information terminal by way of the plug and the jack.

28. A digital camera for the portable information terminal according to claim 26, wherein a circuit switching section is provided in one of the digital camera body and the portable information terminal, said circuit switching section switching between a sound circuit and an imaging circuit, and wherein when the jack and the plug are connected electrically, image data is transferred from the digital camera to the portable information terminal by way of the plug and the jack.

29. A digital camera for the portable information terminal according to claim 25, wherein a mound section is provided around a periphery of the plug of the digital camera body, so that, when the plug is inserted into the jack, the mound section is abutted against a periphery of the jack so that when the digital camera is rotated, a surface of the mound section slides against the periphery of the jack.

30. A digital camera for the portable information terminal according to claim 26, wherein a mound section is provided around a periphery of the plug of the digital camera body, so that, when the plug is inserted into the jack, the mound section is abutted against a periphery of the jack so that when the digital camera is rotated, a surface of the mound section slides against the periphery of the jack.

31. A digital camera for the portable information terminal according to claim 27, wherein a mound section is provided around a periphery of the plug of the digital camera body, so that, when the plug is inserted into the jack, the mound section is abutted against a periphery of the jack so that when the digital camera is rotated, a surface of the mound section slides against the periphery of the jack.

32. A digital camera for the portable information terminal according to claim 25, wherein the plug has a power supply contact, a ground contact, a clock signal transferring contact, and a data transferring contact.

33. A digital camera for the portable information terminal according to claim 26, wherein the plug has a power supply contact, a ground contact, a clock signal transferring contact, and a data transferring contact.

34. A digital camera for the portable information terminal according to claim 27, wherein the plug has a power supply contact, a ground contact, a clock signal transferring contact, and a data transferring contact.

35. A digital camera for the portable information terminal according to claim 29, wherein the plug has a power supply contact, a ground contact, a clock signal transferring contact, and a data transferring contact.

36. A digital camera for the portable information terminal according to claim 32 said digital camera further comprising a base section, wherein the contacts of the plug are arranged from the base section in the following order: (i) the power supply contact, (ii) the ground contact, (iii) the clock signal transferring contact, and (iv) the data transferring contact.

37. A digital camera for the portable information terminal according to claim 32, wherein the ground contact and the clock signal transferring contact of the plug are electrically isolated.

38. A digital camera for the portable information terminal according to claim 36, wherein the ground contact and the clock signal transferring contact of the plug are electrically isolated.

39. A digital camera for the portable information terminal according to claim 25, further comprising an insertion section for threading a cable.

40. A digital camera for the portable information terminal according to claim 25, further comprising:
a movable member supporting the plug so as to be movable with the plug; and
a guide section supporting the movable member so as to be freely movable along a longitudinal axis of the plug and enabling the plug to be housed in the digital camera body.

41. A digital camera for the portable information terminal according to claim 40, further comprising a lens and a lens cover, wherein said lens cover protects the lens of the digital camera and is detachable from the lens by moving with the movable member.

42. A portable digital camera/information terminal system, comprising:
a portable information terminal comprising a jack having a power supply contact, a ground contact, a clock signal transferring contact, and a data transferring contact; said portable information terminal further comprising a terminal body having an inner side and an outer side; and
a digital camera comprising a plug for detachably connecting to said jack, said plug having a power supply contact, a ground contact, a clock signal transferring contact and a data transferring contact; said digital camera further comprising a base section; wherein said contacts of said jack are arranged from said inner side toward said outer side of the terminal body in the following order, first the data transferring contact, second the clock signal transferring contact, third the ground contact, and fourth the power supply contact, and wherein said contacts of said plug are arranged from said base section of said digital camera in the following order, first the power supply contact, second the ground contact, third the clock signal contact.

43. A portable digital camera/information terminal system, comprising;
a portable information terminal comprising a circuit switching section and a jack having a power supply contact, a ground contact, a clock signal transferring contact, and a data transferring contact; said circuit switching section selecting one of a sound circuit and an imaging circuit according to a signal input into the jack and then connecting the selected circuit to the jack; and
a digital camera comprising a digital camera plug for detachably connecting to the jack, said digital camera plug having a power supply contact, a ground contact, a clock signal transferring contact and a data transferring contact, wherein said ground contact and said clock signal transferring contact of the digital camera plug are electrically isolated; and wherein when a plug of an external device is connected to the jack, the circuit switching section identifies the connected external device by measuring an electrical resistance between predetermined contacts of the plug of said external device.

44. A portable information terminal, comprising a data receiving contact and a clock signal transferring contact.

45. A portable information terminal according to claim 44, further comprising a data transmitting contact.

46. A portable information terminal according to claim 44, further comprising a first digital camera connection recognizing section recognizing that a digital camera has been connected to the portable information terminal when a clock signal is input through the clock signal transferring contact.

47. A portable information terminal according to claim 45, further comprising a first digital camera connection recognizing section recognizing that a digital camera has been connected to the portable information terminal when a clock signal is input through the clock signal transferring contact.

48. A portable information terminal according to claim 44, comprising a second digital camera connection recognizing section starting generation of a clock signal when an external device is connected, and recognizing that the external device is a digital camera when predetermined data is received through the data receiving contact.

49. A portable information terminal according to claim 45, comprising a second digital camera connection recognizing section starting generation of a clock signal when an external device is connected, and recognizing that the external device is a digital camera when predetermined data is received through the data receiving contact.

50. A digital camera for a portable information terminal, comprising a data transmitting contact and a clock signal transferring contact.

51. A digital camera for the portable information terminal according to claim 50, further comprising a data receiving contact.

52. A digital camera for the portable information terminal according to claim 50, further comprising a control section outputting a clock signal through the clock signal transferring contact to an external device when the external device is connected.

53. A digital camera for the portable information terminal according to claim 51, further comprising a control section outputting a clock signal through the clock signal transferring contact to an external device when the external device is connected.

54. A digital camera for a portable information terminal according to claim 52 wherein, when the control section receives the clock signal through the clock signal transferring contact, the control section outputs predetermined data through the data transmitting contact.

55. A digital camera for the portable information terminal according to claim 53, wherein, when the control section receives the clock signal through the clock signal transferring contactl, the control section outputs predetermined data through the data transmitting contact.

56. A portable digital camera/information terminal system, comprising
a portable information terminal having a data receiving contact and a clock signal transferring contact, and
a digital camera having a data transmitting contact and a clock signal transferring contact.

57. A portable digital camera/information terminal system, comprising
a portable information terminal having a data receiving contact, a clock signal transferring contact and a digital camera connection recognizing section, and a digital camera having a data transmitting contact, a clock signal transferring contact, and a control section,
wherein said digital camera connection recognition section recognizes that said digital camera has been connected to said portable information terminal when a clock signal is input through the clock signal transferring contact of the portable information terminal, and wherein said control section outputs said clock signal through the clock signal transferring contact of said digital camera to an external device when the external device is connected.

58. A portable digital camera/information terminal system, comprising
a portable information terminal having a data receiving contact, a clock signal transferring contact and a digital camera connection recognizing section, and a digital camera having a data transmitting contact, a clock signal transferring contact and a control section,
wherein said digital camera connection recognizing section starts generation of a clock signal, when an external device is connected to said portable information terminal, and recognizes that the external device is the digital camera when predetermined data is received through the data receiving contact, and wherein said control section of the digital camera receives the clock signal through the clock signal transferring contact of the digital camera and outputs predetermined data through the data transmitting contact.

59. A portable digital camera/information terminal system, comprising
a portable information terminal having a data receiving contact, a clock signal transferring contact and a data transmitting contact, and
a digital camera having a data transmitting contact, a clock signal transferring contact and a data receiving contact.

60. A portable digital camera/information terminal system, comprising
a portable information terminal having a data receiving contact, a clock signal transferring contact, a data transmitting contact, and a digital camera connection recognizing section, and
a digital camera having a data transmitting contact, a clock signal transferring contact, a data receiving contact, and a control section, wherein said digital camera connection recognizing section recognizes that the digital camera has been connected to the portable information terminal when a clock signal is input through the clock signal transferring contact of the portable information terminal, and wherein said control section outputs said clock signal through the clock signal transferring contact of said digital camera device is connected.

61. A portable digital camera/information terminal system, comprising
a portable information terminal having a data receiving contact, a clock signal transferring contact, a data transmitting contact and a digital camera connection recognizing section, and a digital camera having a data transmitting contact, a clock signal transferring contact, a data receiving contact, and a control section, wherein said digital camera connection recognizing section starts generation of a clock signal when an external device is connected and recognizes that the external device is the digital camera when predetermined data is received through the data receiving contact of the portable information terminal, and
wherein the control signal outputs predetermined data through the data transmitting contact of the digital camera when said control section receives the clock signal through the clock signal transferring contact of the digital camera.

62. A portable information terminal, comprising:
a terminal side detection section detecting a transmit-ready signal to indicate a data transmit-able state transmitted from a digital camera; and
a receiving section receiving an image data transmitted from the digital camera;
wherein the receiving section receives said image data after the terminal side detection section has detected the transmit-ready signal.

63. A portable information terminal according to claim 62, wherein, when the receiving section receives said image data, the receiving section detects an abnormality according to a reception abnormality discrimination signal contained in the received image data.

64. A portable information terminal according to claim 62, further wherein, when the receiving section receives said image data, the receiving section detects an abnormality according to a reception abnormality discrimination signal contained in the received image data.

65. A portable information terminal according to claim 63, further comprising an terminal side outputting section outputting a transmit-request signal to request said image data to be transmitted,
wherein, when the terminal side detection section detects the transmit-ready signal, the terminal side outputting section outputs the transmit-request signal to the digital camera, and the receiving section receives said image data transmitted from the digital camera in response to the transmit-request signal.

66. A portable information terminal according to claim 64, wherein the receiving section receives said image data in one block when the transmit-request signal is not interrupted.

67. A digital camera for a portable information terminal, comprising:
a camera side outputting section outputting a transmit-ready signal to indicate an image data transmit-able state to the portable information terminal; and
a transmitting section transmitting an image data in one block to the portable information terminal;
wherein the transmitting section transmits said image data to the portable information terminal after the camera side outputting section outputs a transmit-ready signal.

68. A digital camera for the portable information terminal according to claim 67, further comprising a camera side detection section detecting a transmit-request signal to request said image data to be transmitted from the portable information terminal, wherein, when the camera side detection section detects the transmit-request signal after the camera side outputting section outputs a transmit-ready signal, the transmitting section transmits said image data to the portable information terminal.

69. A portable digital camera/information terminal system, comprising
a portable information terminal having
a terminal side detection section detecting a transmit-ready signal to indicate a data transmit-able state transmitted from a digital camera; and
a receiving section receiving an image data transmitted from the digital camera; and
the digital camera for the portable information terminal, said digital camera having
a camera side outputting section outputting a transmit-ready signal to indicate an image data transmit-able state to the portable information terminal; and
a transmitting section transmitting an image data in one block to the portable information terminal;
wherein the receiving section receives said image data after the terminal side detection section has detected the transmit-ready signal and wherein the transmitting section transmits said image data to the portable information terminal after the camera side outputting section outputs a transmit-ready signal.

70. A portable digital camera/information terminal system, comprising
a portable information terminal having
a terminal side detection section detecting a transmit-ready signal to indicate a data transmit-able state transmitted from a digital camera; and
a receiving section receiving an image data transmitted from the digital camera; and
the digital camera for the portable information terminal, said digital camera having
a camera side outputting section outputting a transmit-ready signal to indicate an image data transmit-able state to the portable information terminal; and
a transmitting section transmitting an image data in one block to the portable information terminal;
wherein, when the receiving section receives said image data, the receiving section detects an abnormality according to a reception abnormality discrimination signal contained in the received image data, and wherein the transmitting section transmits said image data to the portable information terminal after the camera side outputting section outputs a transmit-ready signal.

71. A portable digital camera/information terminal system, comprising
a portable information terminal having
a terminal side detection section detecting a transmit-ready signal to indicate a data transmit-able state transmitted from a digital camera; and
a receiving section receiving an image data transmitted from the digital camera; and
the digital camera for the portable information terminal, said digital camera having
a camera side outputting section outputting a transmit-ready signal to indicate an image data transmit-able state to the portable information terminal; and
a transmitting section transmitting an image data in one block to the portable information terminal;
wherein, when the receiving section receives said image data, the receiving section detects an abnormality according to a reception abnormality discrimination signal contained in the received image data, and wherein the transmitting section transmits said image data to the portable information terminal after the camera side outputting section outputs a transmit-ready signal.

72. A portable digital camera/information terminal system, comprising
a portable information terminal having
a terminal side detection section detecting a transmit-ready signal to indicate a data transmit-able state transmitted from a digital camera; and
a receiving section receiving an image data transmitted from the digital camera, and
a digital camera for the portable information terminal, said digital camera having
a camera side outputting section outputting a transmit-ready signal to indicate an image data transmit-able state to the portable information terminal; and
a transmitting section transmitting said image data in one block to the portable information terminal;
wherein, when the terminal side detection section detects the transmit-ready signal, the terminal side outputting section outputs the transmit-request signal to the digital camera, and the receiving section receives said image data transmitted from the digital camera in response to the transmit-request signal, and wherein the transmitting section transmits said image data to the portable information terminal after the camera side outputting section outputs said transmit-ready signal.

73. A portable digital camera/information terminal system, comprising
a portable information terminal having
a terminal side detection section detecting a transmit-ready signal to indicate a data transmit-able state transmitted from a digital camera, and
a receiving section receiving an image data transmitted from the digital camera; and
the digital camera for the portable information terminal, said digital camera having
a camera side outputting section outputting a transmit-ready signal to indicate an image data transmit-able state to the portable information terminal; and
a transmitting section transmitting an image data in one block to the portable information terminal;
wherein the receiving section receives said image data in one block when the transmit-request signal is not interrupted, and wherein the transmitting section transmits said image data to the portable information terminal after the camera side outputting section outputs a transmit-ready signal.

74. A portable digital camera/information terminal system, comprising
a portable information terminal having
a terminal side detection section detecting a transmit-ready signal to indicate a data transmit-able state transmitted from a digital camera; and
a receiving section receiving an image data transmitted from the digital camera, and
the digital camera for the portable information terminal said digital camera having
a camera side detection section detecting a transmit-request signal to request said image data to be transmitted from the portable information terminal, and
a transmitting section transmitting an image data in one block to the portable information terminal;
wherein, when the receiving section receives said image data, the receiving section detects an abnormality according to a reception abnormality discrimination signal contained in the received image data, and wherein, when the camera side detection section detects the transmit-request signal after the camera side outputting section outputs a transmit-ready signal, the transmitting section transmits said image data to the portable information terminal.

75. A portable digital camera/information terminal system, comprising
a portable information terminal having
a terminal side outputting section outputting a transmit-request signal to request said image data to be transmitted and
a terminal side detection section detecting a transmit-ready signal to indicate a data transmit-able state transmitted from a digital camera, and
the digital camera for the portable information terminal said digital camera having
a camera side detection section detecting a transmit-request signal to request said image data to be transmitted from the portable information terminal, and
a transmitting section transmitting an image data in one block to the portable information terminal;
wherein, when the terminal side detection section detects the transmit-ready signal, the terminal side outputting section outputs the transmit-request signal to the digital camera, and the receiving section receives said image data transmitted from the digital camera in response to the transmit-request signal, and wherein, when the camera side detection section detects the transmit-request signal after the camera side outputting section outputs a transmit-ready signal, the transmitting section transmits said image data to the portable information terminal.

76. A portable digital camera/information terminal system, comprising a portable information terminal having
a terminal side outputting section outputting a transmit-request signal to request said image data to be transmitted and
a terminal side detection section detecting a transmit-ready signal to indicate a data transmit-able state transmitted from a digital camera, and
the digital camera for the portable information terminal said digital camera having
a camera side detection section detecting a transmit-request signal to request said image data to be transmitted from the portable information terminal, and
a transmitting section transmitting an image data in one block to the portable information terminal;
wherein the receiving section receives said image data in one block when the transmit-request signal is not interrupted, and, wherein, when the camera side detection section detects the transmit-request signal after the camera side outputting section outputs a transmit-ready signal, the transmitting section transmits said image data to the portable information terminal.

77. A method for controlling a portable information terminal connectable to a digital camera comprising the steps of:
connecting the digital camera to the portable information terminal; and placing the digital camera into a recording state by pressing a predetermined key provided in an operation section of the portable information terminal for a predetermined period of time; wherein, if a certain key in the operation section is operated when said digital camera is in the recording state, an operation corresponding to a recording function assigned to the certain key is executed.

78. A method for controlling a portable information terminal according to claim 77 further comprising the step of maintaining the digital camera in the recording state, and when a key in the operation section is pressed for a period of time shorter than the predetermined period of time, an operation assigned to the pressed key corresponding to the recording function of the digital camera in the recording state is executed, and if said key in the operation section is pressed for the predetermined period of time, the portable information terminal is placed into a certain key input enabled state.

79. A method for controlling a portable information terminal connectable to a digital camera comprising the steps of
connecting the digital camera to the portable information terminal; and
placing the digital camera into a recording state,
by pressing wherein a predetermined key provided in an operation section of the portable information terminal is pressed for a predetermined period of time, if a predetermined key in the operation section is operated while the digital camera is in the recording state, an operation corresponding to a recording function assigned to the predetermined key is executed.

80. A portable information terminal to which a digital camera can be connected, comprising:
an operation section having a plurality of keys; and
a control section controlling the portable information terminal in such a manner that, when the digital camera is connected to the portable information terminal and a predetermined key provided in the operation section is pressed for a predetermined period of time, the digital camera is placed in a recording state, and, if a certain key in the operation section is operated when the digital camera is in the recording state, an operation corresponding to a recording function assigned to the certain key is executed.

81. A portable information terminal according to claim 80, wherein the control section controls the portable information terminal in such a manner that, the digital camera is placed and maintained in the recording state, and when key in the operation section is pressed for a period of time shorter than the predetermined period of time, the operation assigned to the pressed key corresponding to the recording function of the digital camera in the recording state is executed, and, if said key of the plurality of keys in the operation section is pressed for the predetermined period time while the digital camera is in the recording state, the portable information terminal is placed into a key input enabled state.

82. A portable information terminal to which a digital camera can be connected, comprising:
an operation section having a plurality of keys; and
a control section controlling the portable information terminal in such a manner that, when the digital camera is connected to the portable information terminal and a predetermined key provided in the operation section of the portable information terminal is pressed for a predetermined period of time, the digital camera is placed into a recording state, and while said digital camera is in the recording state, if a predetermined key in the operation section is operated, an operation corresponding to a recording function assigned to the predetermined key is executed.
